(19) United States
(12) Patent Application Publication
(10) Pub. No.: US 2012/0325327 A1
(43) Pub. Date: Dec. 27, 2012

(54) Compressed Air Recovery Device, Compressed Air Supply System Comprising a Compressed Air Recovery Device and Corresponding Recovery Module, As Well As Method for Operating a Compressed Air Recovery Device, Control Module and Vehicle Comprising a Compressed Air Recovery Device

(75) Inventors: Detlev Eggebrecht, Hannover (DE); Konrad Feyerabend, Hannover (DE)

(73) Assignee: WABCO GMBH, Hannover (DE)

(21) Appl. No.: 13/581,642

(22) PCT Filed: Mar. 24, 2011
(86) PCT No.: PCT/EP2011/001462

§ 371 Date: Aug. 29, 2012

(30) Foreign Application Priority Data
Apr. 30, 2010 (DE) 10 2010 018 949.9

(51) Int. Cl. F17D 1/02

(52) U.S. Cl. 137/1; 137/599.01

(57) ABSTRACT

The invention relates a compressed air recovery device, a compressed air supply system and a recovery module as well as to a method for operating a compressed air recovery device, to a control module and to a vehicle. A compressed air recovery device (30) comprises a compressed air inlet (1) to which a compressor (2) can be connected. The compressed air inlet (1) is connected to a pressure line (3) to which a system pressure line (5) is connected via a non-return valve (4). A drying unit (11) is arranged in the pressure line (3). A regeneration path (22) which can be connected to the system pressure line (5) depending on the switch position of a vent control valve (23) runs into the pressure line (3) between the drying unit (11) and the non-return valve (4). The supply of compressed air to the compressed air inlet (1) can be controlled by an electrically actuated supply control valve (17). In order to allow a varied and effective compressed air recovery at low cost, the throughput of compressed air through the regeneration path (22) is linked to the position of both the supply control valve (17) and the vent control valve (23).

The present invention generally relates to a compressed air recovery device as claimed in the preamble of claims 1, 6 and 8, a compressed air supply system for a vehicle as claimed in the preamble of claim 12, as well as a recovery module for a compressed air recovery device or a compressed air supply system as claimed in claim 17. The invention further relates to a method for operating a compressed air recovery device as claimed in the preamble of claim 19 and a control module as claimed in claim 22 as well as a vehicle as claimed in claim 23.

EP 1 318 936 B1 discloses a vehicle compressed air braking system comprising a compressed air recovery device, of which the pressure line can be fed with compressed air from a compressor. A system pressure line is connected to the pressure line via a check valve. A drying device is arranged in the pressure line and removes vapor and suspended particles from the compressed air fed from the compressor.

In a conveying mode, the compressed air fed from the compressor is conveyed via the drying device into the system pressure line, where it is made available for use in compressed air consumer circuits.

In the conveying mode, a bleed line branches off from the pressure line before the drying device in relation to the direction of flow, that is to say on the side of the drying device opposite the system pressure line, wherein a pneumatically actuatable bleed valve is arranged in the bleed line. To regenerate the drying device, the known compressed air recovery device provides a regeneration path, which can be connected to the system pressure line via a bleed control valve in a regeneration mode. The regeneration path discharges between the drying device and the check valve into the pressure line. In the regeneration mode, the bleed control valve connects the system pressure line to the pressure line and allows compressed air to flow through the drying device through the regeneration path, against the direction of flow in the conveying mode. In the regeneration mode, the bleed valve is switched into the open position so that the regeneration air from the drying device can flow off through the bleed line.

An electrically actuatable feed control valve is provided for pressure control and is arranged between the system pressure line and a compressor control line. A pneumatic switch element of the compressor is connected to the compressor control line so that the compressed air feed from the compressor can be interrupted by switching the feed control valve.

In the known compressed air recovery device, the bleed valve is actuated by the bleed control valve, whereby the opening of the regeneration path is necessarily coupled to the opening of the bleed line. In a cold environment in particular, for example during winter operation of a vehicle, a cold mode is advantageous, wherein the bleed line is opened whilst the compressor is running. Icing can thus be counteracted using hot air of the compressor, and it may be possible to dispense with heating devices at the bleed valve where applicable. In the known device, in which the opening of the bleed valve is linked to the release of the regeneration path, a cold mode is not possible without return flow through the regeneration path. In the cold mode, compressed air is therefore lost from the volume of the pressure line and from the regeneration path, and has to be re-conveyed from the compressor once the cold mode has been terminated. The energy requirement of the compressor to re-convey compressed air leads to a correspondingly increased fuel consumption of the vehicle.

DE 10 2007 009 768 B4 provides a compressed air supply device for a commercial vehicle, in which the compressor control line for the compressor is linked to the regeneration path and the bleed valve is opened by an electric solenoid valve, independently of the opening of the regeneration path. A cold mode is thus indeed possible whilst the compressor is running, without simultaneous opening of the regeneration path. However, a consumer is connected to the compressor control line as a result of the fluidic connection between the regeneration path and the compressor control line. In many operating states, only a reduced switching pressure is thus available for the pneumatic switching of the compressor. Rapid switching of the compressor, which is desired or even necessary in many operating modes, cannot be ensured with the known device as a result of the pressure loss over the regeneration path.

In addition, with the known device there may be a loss of pressure in the system pressure line when the compressor is switched off if the pressure line between the compressor and the drying device is not completely tight, and air flows out from the system via the regeneration path. This is the case in particular in older compressors, when oil carbon has built up on the check valves in the compressor and blocks the pressure line so that the pressure line loses pressure when the compressor is switched off.

In many applications, in particular where there is a high compressed air requirement, such as in articulated buses and similar vehicles, compressed air also cannot be conveyed quickly enough with the above-described compressed air recovery devices according to the prior art, since no compressed air is fed to the compressor during the regeneration of the drying device. Compressed air recovery devices having two drying devices have therefore been proposed, wherein one drying device allows the further feed of compressed air, whilst the other drying device regenerates.

U.S. Pat. No. 4,812,148 discloses a compressed air recovery device having two drying devices, of which the outlets are each connected to a compressed air container with interconnection of a check valve. The outlets of the drying devices are also in constant connection via a throttle line. The inlets of the drying devices are each connected to an electromagnetic control valve, which is supplied by a compressor. The electromagnetic control valves can be switched between two switch positions by a control circuit so that the respective associated drying device is either connected to the compressor or is bled. The control valves are located in different switch positions, wherein a partial flow of the compressed air flow leaving the active drying device is always removed via the throttle line and the bled drying device, and the bled drying device thus regenerates. The switch positions of the two electromagnetic control valves are changed at predetermined intervals so that the respective other drying device is activated or regenerated respectively.

U.S. Pat. No. 5,209,764 describes a compressed air recovery device having two drying devices, of which one is activated and the other is regenerated. To this end, the drying devices are each assigned electric control valves, which are switched by a relay. The relay is controlled by a timer. After predetermined intervals, the switch positions of both control valves are changed Both drying devices are thus activated and regenerated alternatively, until a maximum system pressure is reached in the compressed air container and the compressed air feed is switched off by the compressor.

With the known compressed air recovery devices having two alternatively operated drying devices, the compressed air feed can indeed be maintained when one drying device regenerates. However, this requires a high level of structural complexity with a plurality of control valves and switching devices for the observance of the provided intervals (relays and the like). In addition, the necessary component parts, in particular the expensive electromagnetic control valves for each drying device, increase the production costs of the compressed air recovery device. In particular however, regeneration is carried out on a rotational basis in the known compressed air recovery devices, even if regeneration is not necessary. A considerable part of the compressed air conveyed from the compressor is thus bled in a futile manner and the efficiency of the compressed air recovery device is thus reduced.

Compressed air recovery devices and compressed air supply systems comprising compressed air recovery devices are to be produced as cost effectively as possible as component parts of vehicles and must function as effectively as possible

Based on the above, the problem addressed by the embodiments of the present invention is to create a compressed air recovery device, a compressed air supply system and a recovery module, as well as a method for operating a compressed air recovery device, a control module, and a vehicle, thus enabling versatile and effective compressed air recovery for a vehicle at low production and operating costs.

The problem is solved in accordance with the embodiments of the present invention by a compressed air recovery device having the features of claim 1, 6 or 8, or by a compressed air supply having the features of claim 12, or by a recovery module having the features of claim 17. The problem is further solved by a method for operating a compressed air recovery device according to claim 19, a control module according to claim 22, and a vehicle according to claim 23.

According to one embodiment of the invention, the fuel consumption of the vehicle can be reduced and the efficiency of the compressed air recovery device may be improved by linking the opening of the regeneration path with full passage cross-section to the position both of the feed control valve and of the bleed control valve. The full throughput of the regeneration path is only given if both the feed control valve and the bleed control valve are switched into an open position. It can thus be ensured that the regeneration path can only open completely in the regeneration mode if the full flow rate is desired in the regeneration path. In a cold mode, if the compressor is to be run further, the electrically actuatable feed control valve can remain unactuated and therefore also can prevent the release of the full passage cross-section of the regeneration path.

The bleed control valve can advantageously be an electrically actuatable solenoid valve, which can be switched quickly and precisely in coordination with the feed control valve.

In an advantageous embodiment of the invention, the regeneration path can comprise a first line portion connected to the feed control valve and a second-line portion parallel to the first-time portion and connected to the bleed control valve. The line path can thus have two parallel line portions, which together can form the total volume or the effective passage cross-section. If only the bleed control valve is actuated, and therefore the bleed valve switches into the open switch position and also releases its assigned line portion of the regeneration path, the first line portion, assigned to the feed control valve, remains closed. Only a highly reduced volume of air can thus flow out from the system pressure line via the regeneration path in the cold mode, when the compressor is to be run further and hot air is to be removed through the bleed line. The pressure loss in cold mode, which is conveyed again by the compressor upon termination of the cold mode, is reduced by the division of the regeneration path between the feed control valve and the bleed control valve.

Even if the feed control valve is brought into the open position and the bleed control valve is closed, the compressor is thus switched off and no regeneration takes place and the maximum volume of air flowing off with an untight pressure line between the compressor and the air drier is reduced considerably compared to known arrangements.

In a preferred embodiment of the invention, the feed control valve and the bleed control valve can be arranged and connected in such a way that the regeneration path can only be released with the simultaneous presence of the switch positions of the feed control valve and of the bleed control valve provided for the regeneration mode. The bleed control valve and the feed control valve can thus be combined as an “and link” of a condition for release of the regeneration path, and therefore the regeneration path is only released in the regeneration mode. In the cold mode, with running compressed air feed though the compressor, the regeneration path remains closed so that no appreciable pressure losses are produced.

The regeneration path advantageously can have a regeneration valve arrangement, which can be switched cumulatively by actuation both of the feed control valve and of the bleed control valve into the open position of the regeneration path. The regeneration path can thus be switched reliably, and an undesired airflow over the regeneration path can be avoided. At the same time, it is possible in many applications of a compressed air recovery device to dispense with a check valve in the regeneration path due to the regeneration valve arrangement.

A connection of this type of the feed control valve and of the bleed control valve as a cumulative condition (and link) for the release of the regeneration path via the regeneration valve arrangement can thus be provided at a low level of structural complexity due to the arrangement of either the feed control valve or the bleed control valve in the regeneration path. The regeneration valve arrangement can be controlled by the respective other valve (bleed control valve/feed control valve), which is not arranged in the regeneration path.

In a further embodiment, only the regeneration valve arrangement is provided in the regeneration path and can be switched cumulatively into the open position of the regeneration path by actuation both of the feed control valve and of the bleed control valve. The regeneration path can thus be formed in a particularly short manner in the pressure line as a bypass of the check valve, wherein merely the regeneration valve arrangement and possibly a baffle are provided in the regeneration path. The feed control valve and the bleed control valve act merely as pneumatic switch elements, without appreciable sustained airflow. They can therefore be dimensioned accordingly with a small opening cross-section and thus in a more cost effective manner.

In one embodiment, the regeneration valve arrangement can be a pressure-controlled regeneration valve comprising two control inlets, of which one control inlet is connected to the feed control valve and the other control inlet is connected to the bleed control valve. This regeneration valve can only switch into the open position if both control inlets are pressurized.

In another embodiment, the regeneration valve arrangement can consist of two simple regeneration valves, arranged in series in the regeneration path and each having a pneumatic control inlet. One of the regeneration valves can be connected to the feed control valve and the other regeneration valve is connected to the bleed control valve. The passage of the regeneration path is thus only opened if both the feed control valve and the bleed control valve are actuated and thus switch the respective regeneration valves assigned thereto into the open position.

According to a further embodiment of the invention, the efficiency of the compressed air recovery device can be increased considerably by a recovery module comprising a drying device having a parallel pressure line arranged parallel to the pressure line. The parallel pressure line through the recovery module can be released by a shuttle valve, alternatively to the pressure line of the compressed air recovery device. By switching on the recovery module, the compressed air can also continue to be conveyed if the drying device of the compressed air recovery device is regenerated. The losses of compressed air in the compressed air consumer circuits can thus be replenished quickly, even in applications with increased compressed air requirement, such as in articulated buses. A workload of the compressor up to 97% or more can be achieved with the recovery module according to the invention, that is a practically continuous conveying mode can be maintained in the system pressure line with increased compressed air requirement in the compressed air consumer circuits.

The production costs of the compressed air recovery device can be kept low, since the recovery module, which can be switched on by means of the shuttle valve, is of simple design compared to a primary module and is equipped with cost-effective component parts, in particular without electrically actuated or read component parts. A regeneration path in the recovery module is advantageously released by a pneumatically controlled governor valve, to which system pressure is constantly applied. The compressed air recovery process takes place primarily through the primary module, which can be controlled very finely and therefore is highly efficient, and the recovery module is only activated selectively when regeneration of the drying device in the primary module is required. The primary module can preferably be an electronically controlled compressed air recovery device, which can also be used in vehicles having a low air requirement. It differs from a compressed air recovery device for applications with a high air requirement merely in its control algorithms.

In accordance with a further embodiment of the invention, the recovery module can be an assembly having exclusively pneumatic elements, which can be prefabricated in a cost effective manner and can be used in modular compressed air systems or retrofitted in existing compressed air recovery systems. The recovery module comprises a compressed air inlet, to which a compressor can be connected. There can be a connection via the compressed air inlet to a pressure line in the recovery module, in which a drying device is arranged. The recovery module has a bleed line branching off before the drying device and having a bleed valve, and a regeneration path discharging after the drying device, said regeneration path being releasable by a governor valve controlled in a pressure-dependent manner. A control inlet of the bleed valve in the bleed line can advantageously be connected to a regeneration pressure line between the governor valve and the pressure line. The actuation of the bleed valve can therefore be controlled by the governor valve and can take place without further components. System pressure can be applied constantly to the governor valve controlled in a pressure-dependent manner, said valve releasing the regeneration path as soon as a specific switch pressure has been reached. The switch pressure of the governor valve can be adjusted by a valve spring.

The recovery module can be fixed as a pneumatic component part, without electrical supply, to the compressed air recovery device in an application in a parallel pressure line of a compressed air recovery device, thus enabling a cost-effective modular design. Previously existing compressed air recovery devices can also be retrofitted with a recovery module for applications with increased compressed air requirement. The arrangement of a recovery module also requires a modular design of a compressed air supply system, in which, in addition to the compressed air recovery, the multi-circuit protection valve and component parts of the control devices are also arranged as modules and can be combined in a vehicle depending on the intended use of the compressed air supply system.

The recovery module with governor control by means of a control valve controlled in a pressure-dependent manner provides a simple and cost-effective possible embodiment of the recovery module, which can be switched on during regeneration in the compressed air recovery device, alternatively to maintenance of the conveying mode.

The shuttle valve can advantageously be pneumatically actuatable and can be linked to the actuation of the bleed valve in the compressed air recovery device to switch between the compressed air recovery device and the recovery module. The compressed air from the compressor can thus be switched to the recovery module without further component parts and therefore in a cost effective manner, if the bleed valve is opened for regeneration of the drying device in the compressed air recovery module.

Advantageously, two structurally like recovery modules can be provided, which can be activated alternatively by the shuttle valve. An electrically actuatable feed control element of the recovery device may be arranged outside the recovery modules. The recovery modules arranged in parallel have exclusively pneumatic elements and are therefore cost effective.

According to a further embodiment of the invention, the bleed control valve can be a pneumatically actuatable governor valve, which can be arranged in the regeneration path and can be controlled constantly by the pressure in the system pressure line or by a line connected to the system pressure line, in particular by a compressed air consumer circuit which is not pressure-limited. It is possible to dispense with an electrically actuatable solenoid valve as a bleed control valve for controlling regeneration. A pneumatically actuatable valve is much more favorable, and therefore the production costs of the compressed air recovery device are reduced. In addition, the pneumatic bleed control valve ensures regular regeneration of the drying device, even if the electronic control or the electric feed control element should fail, for example due to a blown fuse, thus enabling practically unlimited continued travel of the vehicle.

During operation of the compressed air recovery device, the pneumatically actuatable bleed control valve can release the regeneration path when the switch pressure is present in the system pressure line and blocks the regeneration path when the system pressure again falls to a switch-back pressure. The switch-back pressure is understood to mean the minimum pressure which must be present at the control inlet of the bleed control valve to bring the bleed control valve into the second switch position against a resilient force, the system pressure line being connected to the regeneration path in said second position.

The pressure level (less than the switch pressure) at which the bleed control valve switches back into the first switch position from the second switch position when the pressure falls will be referred to hereinafter as the switch-back pressure. The pressure difference between these two pressures is caused by hysteresis.

If the control of the bleed valve is linked to the bleed control valve, the bleed line can be opened automatically, without electric position commands. The bleed line is nevertheless opened by means of the operating method described hereinafter, controlled by the feed control valve.

During operation of the compressed air recovery device, the desired operating mode of the compressed air recovery device, namely in particular a conveying mode, an idle mode, and a regeneration mode, is controlled exclusively by the electrically actuatable feed control valve in the form of a control element, since the feed control valve switches the compressed air feed on or off according to a control device. In accordance with a further embodiment of the invention, a control module is provided to carry out the method described below for operating the compressed air recovery device and comprises a control unit for controlling the electrically actuatable feed control valve. The control unit is assigned a signal outlet and/or an internal signal line for connection of the electrically actuatable feed control valve of the compressed air recovery device. An electric control signal of the control unit can be emitted for the feed control valve via the signal outlet or the signal line. If the feed control valve is arranged within the control module in an advantageous embodiment, the control unit emits the electric actuation signal for the feed control valve via an internal signal line to the feed control valve, that is to say a signal line arranged within the control module.

The compressed air feed to the compressed air recovery device can thus be controlled by the control module via the control signal. The control unit in the control module can be formed in such a way that a desired operating mode of the compressed air recovery device can be controlled under consideration of a system pressure of the compressed air recovery device. One or more pressure sensors can be advantageously connected to the control unit for determination of the system pressure and are arranged in a system pressure line of the compressed air recovery device or in a line connected to the system pressure line, in particular a compressed air consumer circuit.

The control module thus forms a separate assembly in a compressed air supply system, said assembly controlling the operating modes of the compressed air recovery device via the feed control valve. As described below, the compressed air supply system can be formed with further modular assemblies, in particular a recovery module and a modular assembly of a multi-circuit protection valve. It is thus possible, via the feed control valve, for the control module to control assemblies operating exclusively pneumatically.

In a conveying mode, the feed control valve is not energized and therefore switches on a compressed air feed through the compressor so that compressed air is conveyed through the recovery device to the system pressure line and therefore ultimately to the compressed air consumer circuits. During the conveying mode as a desired operating mode, the compressed air feed is interrupted when a predetermined switch-off value of the system pressure is reached, said value being lower than the switch pressure of the governor valve. A change is thus made to an idle mode, in which the compressed air feed from the compressor is interrupted, but the pressure in the pressure line and in the drying device is maintained. The conveying mode is thus controlled within a pressure band, which is defined upwardly by the switch pressure and by the switch-off value, lying below the switch pressure, for the conveying mode.

In an advantageous embodiment of the invention, the conveying mode and the idle mode are sub-modes of a normal operating mode and are controlled by the control device or by the control module via the feed control device. A change between conveying mode and idle mode can be implemented by switching the compressed air feed on and off within the scope of a normal operating mode, preferably depending on the travelling sit uation of a vehicle equipped with the compressed air recovery device. A conveying mode can thus be provided in particular if the vehicle is in a thrust phase and is not under load, for example approaching a red traffic light or travelling downhill. In such thrust operating phases, the operation of the compressor can be assisted by recovery of kinetic energy of the vehicle (recuperation), without the use of fuel. In operating phases of the vehicle at high load, a change is made to idle mode where possible and the compressor is switched off. The bleed line is kept closed in idle mode so that the pressure in the pressure line and in the drying device remains practically constant. If a change is again made to conveying mode as soon as a thrust phase is present, the system pressure is reached again almost immediately and compressed air is conveyed into the system pressure line.

If a regeneration mode is required, since the drying device is to be regenerated, the compressed air feed can thus be switched on and maintained above the switch-off value until the system pressure exceeds the switching pressure of the bleed control valve. If the compressed air recovery device or the compressed air supply system is in idle mode at the time of request for regeneration, the compressed air feed is thus switched on in accordance with the conveying mode, independently of the control of the change between conveying mode and idle mode, via the evaluation of the travelling situation of the vehicle.

If a regeneration of the drying device is requested, the switch state of the governor valve is thus monitored and the control unit, which generates the electric control signal for the feed control valve, indicates a change to the switch state. As soon as a switching of the governor valve with an overshoot of the switch pressure is identified, the control unit can prompt a shut-off of the compressed air feed in accordance with an advantageous embodiment. To this end, the feed control valve is actuated and thus switches off the compressor.

A change to the switch state of the bleed control valve can advantageously be determined by means of a sensor assigned to the bleed control valve, said sensor indicating to a control unit, which controls the feed control valve, the switch state of the bleed control valve. The sensor changes its outlet value with the switching of the bleed control valve. For example, the sensor can be formed as an electric switch or path sensor.

In a further embodiment, the switch state of the bleed control valve can be established from ongoing measurements of a pressure value representative of the system pressure, also without additional electric component parts on the bleed control valve. The measured values of a pressure sensor in the system pressure line or in the compressed air consumer circuits can be utilized for this purpose. Since the switching of the bleed control valve and release of the regeneration path are manifested by a continuous fall in system pressure, it is possible to conclude when evaluating the progression of the pressure that the bleed control valve has been switched when there is a corresponding fall in pressure.

The volume of the compressed air flowing back in the regeneration mode can be determined by the automatic switching and switching back of the governor valve. The switching pressure and the switch-back pressure in the two switched positions are adjusted via a valve spring of the governor valve and constructively via the surface conditions of the pressurized surfaces in the valve, in such a way that precisely the air volume provided for complete regeneration flows through the regeneration path.

In an advantageous embodiment of the operating method, a switch-off value of the system pressure above the switch pressure of the bleed control valve is predetermined for the regeneration mode. The compressed air feed therefore is not interrupted until the switch pressure of the governor valve has been reached and regeneration has been initiated. As soon as the governor valve has switched, the bleed valve opens and the airflow from the compressor is diverted via the bleed valve so that the pressure in the system pressure line does not increase further. In addition, the energy consumption of the compressor can be reduced once the governor valve has been switched by feeding a corresponding electrical control signal to the feed control valve.

In order to establish the need of the requirement of the regeneration mode, the volume of moisture received by the drying device is determined in a preferred embodiment and is used as a basis to establish the regeneration need.

The compressed air consumption from the system pressure line for the regeneration mode is thus minimal if, in accordance with an embodiment of the invention, the regeneration mode is always initiated if the volume of moisture received corresponds to the volume value of moisture which can be regenerated before the bleed control valve switches back. The volume of moisture which can be regenerated is set by the switch pressure and the switch-back pressure of the bleed control valve. The volume value of moisture which can be regenerated between switching and switching back of the bleed control valve with the compressed air volume flowing back is advantageously determined by the switch pressure and the switch-back pressure of the bleed control valve and by the holding volume of the compressed air containers, which are connected to the system pressure line and from which the regeneration air can flow back.

The volume of moisture introduced can be established or estimated either by a moisture sensor or by estimating the volume of air which has flowed through in the direction of conveyance. A prognosis of the additional volume of moisture which will be introduced, together with the air flowing through the drying device, before the governor valve is switched is preferably considered when establishing the volume of moisture received in the drying device to request the regeneration mode. To this end, a prognosis algorithm is programmed in the control unit, which determines the operating mode of the compressed air recovery device via the feed control valve and initiates the regeneration mode in the event of a regeneration requirement. The current or average compressed air consumption of the vehicle over time is advantageously considered in order to determine precisely a time window until the switch pressure is reached and to improve the accuracy of the prognosis of the volume of moisture still to be introduced before the governor valve is switched.

In a further embodiment, the driver can also request regeneration manually. Alternatively to the automatic initiation of the regeneration mode via the establishment of the volume of moisture received, the regeneration is then initiated on the basis of the manual request made by the driver. The need or a favorable opportunity for manually initiated regeneration is displayed to the driver if predefined operating states of the vehicle are present, and therefore immediate regeneration can be initiated. For example, such operating states are present at standstill of the vehicle. When the vehicle is parked, for example overnight or for longer periods, the moisture can be removed from the drying device by means of manually initiated regeneration. In particular in cold ambient air, icing of the moisture in the drying device is thus counteracted effectively. At standstill with the engine running, the driver can request regeneration, for example by a separate button or by the combination of existing inlet media, such as an accelerator pedal, clutch, and brakes.

If, during regeneration, air is removed from the system pressure line by other consumers, such as the braking system or suspension of the vehicle, the volume of air which would be used for regeneration is reduced. Too little regeneration air fed back may possibly be compensated for in subsequent regenerations. The volume of air actually used for regeneration can be established by determining the progression of the pressure in the interval between switching and switching back of the bleed control valve, and the volume of returned air can be calculated from this. A possible remaining volume of residual moisture is established from the returned volume of air, and the volume of residual moisture in future regeneration mode intervals is considered during initiation of the regeneration mode. The remaining volume of residual moisture forms a starting value when determining the volume of moisture in the drying device, which the control unit uses as a basis for an algorithm for making a decision regarding the initiation of regeneration. If less regeneration air has flowed back than expected, the calculated remaining volume of residual moisture can thus be utilized for the calculation of the next regeneration point.

The switch-off value of the system pressure, which is used as a basis in conveying mode to switch off the compressed air feed, advantageously lies within a pressure band, which can be defined by the switch pressure and the switch-back pressure of the bleed control valve. The switch-off value for the conveying mode thus lies close to the switch pressure of the bleed control valve so that a wide pressure band is given for the conveying mode. With a pressure band for the conveying mode of 8 to 12.5 bar for example, the switch-off value may lie at approximately 12.3 bar, and therefore the pressure band can be utilized largely for the conveying mode and reliable switching off of the compressed air feed before undesired regeneration is begun is also ensured. A regeneration mode is initiated selectively by the control unit of the compressed air recovery device as required by ignoring the switch-off value for the conveying mode and maintaining the compressed air feed until the system pressure exceeds the switch pressure of the bleed control valve. In accordance with an advantageous embodiment of the present invention, a switch-off value for switching off the compressed air feed is specified to the control unit for the regeneration mode and is higher than the switch pressure of the bleed control valve so that the system pressure is raised above the switch pressure of the pneumatic bleed control valve.

In an embodiment of the present invention, the switch pressure of the bleed control valve can be determined, compared with measured values of the respective pressure from previous regeneration mode intervals, and the switch-off value for switching off the compressed air feed in the conveying mode is adapted to the established deviation of the switch pressure for subsequent regeneration processes. Changes when the bleed valve responds to the prevailing system pressure can thus be compensated for, said changes possibly occurring in a desired manner or due to environmental influences. The switch-back pressure of the bleed control valve is optionally considered when establishing an adaptation of the switch-off value for switching off the compressed air feed. The switch pressure and switch-back pressure may be different due to slightly changed adjustment of the governor valve. They can also change as a result of ageing of the governor valve and temperature influences.

The pneumatically actuatable bleed control valve can be a 3/2 valve in an embodiment of the present invention and can have a service connector connected to the compressor control line, a supply connector connected to the system pressure line, and a bleed connector. A 3/2 valve is available at low cost and can provide governor control of the regeneration path, wherein the operating modes of the compressed air recovery device are initiated by the control of the electrically actuatable feed control valve. The further compressed air feed is inhibited independently of the control of the electrically actuatable feed control valve, as soon as the system pressure exceeds the switch pressure of the bleed control valve. The bleed control valve then actuates the bleed valve, whereby the compressed air flow of the compressor is guided through the bleed line. The maximum system pressure is therefore determined by the switch pressure of the bleed control valve, and an undesired rise in pressure in the system pressure line is excluded, even after a failure of electric components.

The control unit, which may be arranged in a control module, is designed to control the above-described embodiments of the operating method. In particular, it comprises the corresponding means for evaluating and generating inlet signals and outlet signals for the control process. The above-described approaches during control and evaluation are programmed in corresponding algorithms in the control unit.

In accordance with a further embodiment of the invention, the compressed air recovery device comprising a pneumatically actuatable bleed control valve is a component part of a compressed air supply system, which, apart from the compressed air recovery device, also comprises a compressor, a multi-circuit protection valve connected to the system pressure line, and an electronic control unit for generating electric valve control signals. In accordance with an embodiment of the invention, the compressed air recovery device, the multi-circuit protection valve and the control unit each form modular assemblies, wherein the feed control valve is arranged outside the assembly of the compressed air recovery device, namely a recovery module. The recovery module is thus a purely pneumatic assembly with no electrically actuatable component parts. The structural margin for play when designing the compressed air supply system is widened without consideration of electrical supply connectors on the compressed air recovery device. In addition, due to the modular design, there are a multiplicity of structural combination options of the modular assemblies for accommodating, simply and cost effectively, the respective needs with use in vehicles.

The compressed air supply system can also be operated by the above-described method, wherein the electrically actuatable feed control valve controls the desired operating modes of the compressed air recovery device and of the recovery module via control of the compressed air feed.

The modular assemblies can be separate component parts, which can be interconnected releasably or rigidly however in the provided combination for the respective application of a compressed air supply system.

The control module can be a modular assembly having a control unit, which generates control signals for the feed control valve and controls the compressed air feed to the compressed air recovery device via the control signal.

The electrically actuatable feed control valve can advantageously be assigned to the compressor, and therefore a very short and thus reliable connection is required between the feed control valve and the compressor. Furthermore, due to the short connection between the feed control valve and the compressor, only an electric cable is necessary to actuate the feed control valve. A longer compressor control line, which was required in known arrangements of feed control valves within compressed air recovery devices in the vicinity of the drying device, can be dispensed with. Signal transfer is also reduced by the arrangement of the feed control valve in the vicinity of the compressor. In addition, the volume of the short compressor control line between the feed control valve and the compressor is very low, which is beneficial for the quality of the signal transfer.

In a preferred embodiment of the invention, the feed control valve can be arranged in the assembly of the control unit, that is to say in the control module. In this embodiment the feed control valve is connected to the control unit by an internal signal line, that is to say a signal line arranged within the control module. The control module then has a connector for connection of the compressor control line. The arrangement of the feed control valve in the control module is advantageous, since, in addition to a pneumatic supply, the control module also has an electrical supply, for example for measurement of the pressure conditions in the compressed air consumer circuits, and therefore the electric feed control valve in the modular compressed air supply system according to an embodiment of the invention can use the electrical supply of the control module. A switch request to the electric control valve can thus be made without additional electric cables and plugs.

Both the recovery module and the multi-circuit protection valve are preferably formed as purely pneumatic assemblies. These assemblies are thus preferably provided without electric sensors and electrically actuated valves. If electric devices are provided in the assembly of the multi-circuit protection valve, the electrically actuatable feed control valve can be integrated in the assembly of the multi-circuit protection valve in a further advantageous embodiment. There, the supply connector of the feed control valve can be connected to line parts, in which the system pressure prevails, in the multi-circuit protection valve by means of short flow paths, for example short ducts in the housing wall of the multi-circuit protection valve.

A control module which contains the control unit, can be fitted on the assembly of the multi-circuit protection valve, and has line portions to at least one compressed air consumer circuit is advantageous. A pressure sensor is arranged in at least one of the line portions of the compressed air consumer circuits and is connected to the control unit. The control unit can therefore determine a pressure value, representative of the system pressure, in the at least one compressed air consumer circuit, in which the pressure sensor is arranged. The feed control valve is controlled by means of the measured pressure value, wherein the provided switch-off value for the compressed air feed can be determined precisely both in conveying mode and in regeneration mode of the compressed air recovery device.

The integration of the pressure sensor in the control module has the advantage that no further cables and plugs are required for signal transfer. The control module can also be exchanged easily, and an improved control module with further capabilities can be retrofitted.

In an embodiment of the invention, a pressure sensor connected to the control unit can be arranged in any of the compressed air consumer circuits, and therefore the control unit can determine different system pressures in the compressed air consumer circuits on the basis of the measurement results of the pressure sensors. At least one of the pressure sensors can be utilized for pressure control, that is to say for calibration with the switch-off value of the compressed air feed.

The control unit is advantageously designed for the parallel control of a plurality of systems of a vehicle so that a plurality of control tasks can be implemented by a common control unit. The number of separate electrical and pneumatic systems in the vehicle is thus reduced, which has an advantageous effect on manufacturing costs. The measured values of the pressure sensors in the control module can be incorporated in the further controllable systems of the vehicle, such as anti-lock braking systems, electronic braking systems, or electronic parking brake systems. Control is achieved via a common control unit. In other words, at least one pressure sensor among a plurality of pressure sensors in different compressed air consumer circuits, which are necessary for systems other than the compressed air supply, can be utilized for control of the compressed air feed valve. The control of the compressed air supply system advantageously reverts to one or more pressure sensors of the service braking circuits of the vehicle.

In a particularly preferred embodiment of the design of the compressed air supply system, the electronic control devices for further controllable systems can be housed in the control module so that the electronics provided are used in a combined manner for a plurality of systems. The electronic control unit of the compressed air supply system can particularly advantageously be combined with an electronic parking brake (EPH), wherein the switch valves of the EPH system can also be housed in the control module.

Further embodiments of the invention will emerge from the dependent claims and from the exemplary embodiments, which will be explained in greater detail hereinafter on the basis of the accompanying drawings, in which:

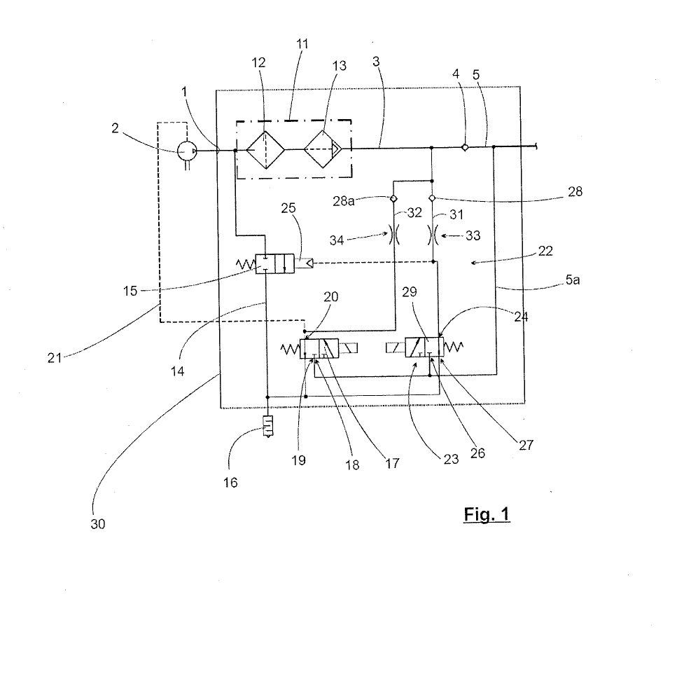

FIG. 1 to

FIG. 7: show pneumatic circuit diagrams of compressed air recovery devices with control of the regeneration path both by feed control valve and by bleed control valve,

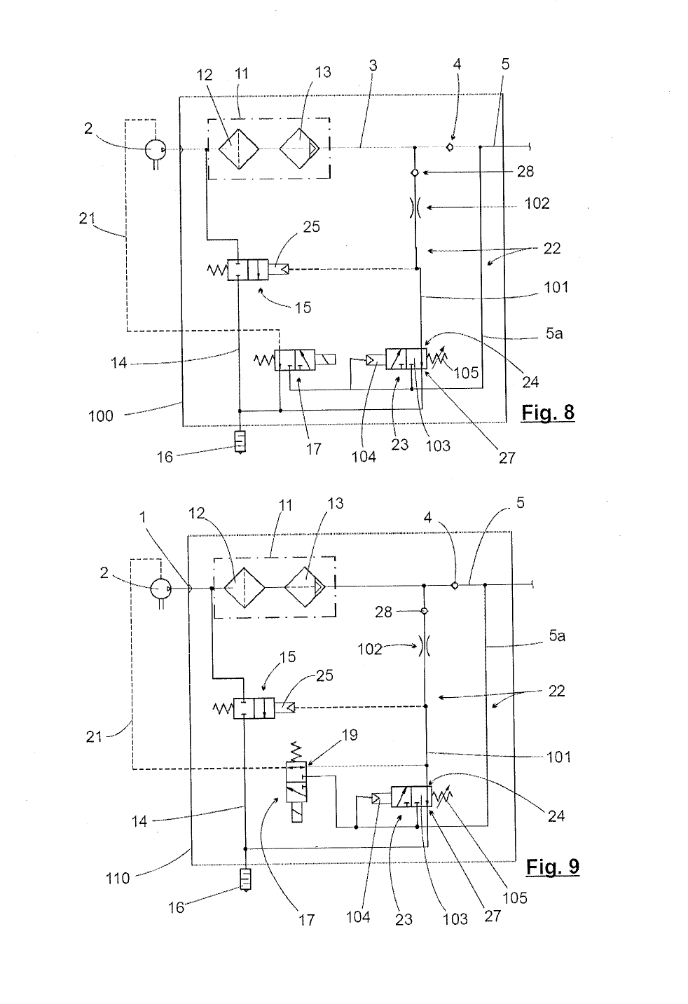

FIG. 8 and

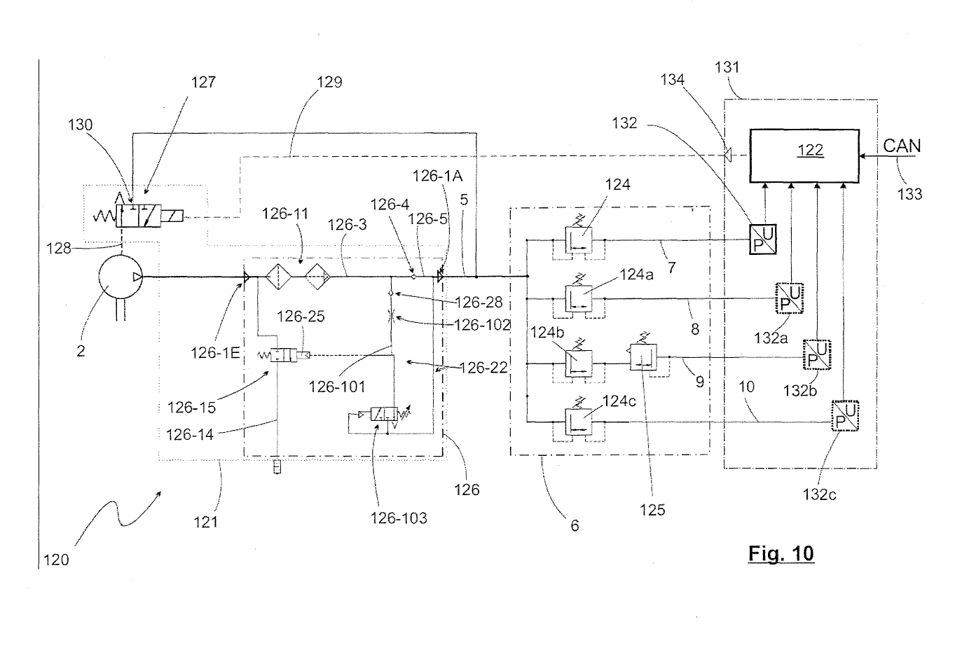

FIG. 9: show pneumatic diagrams of compressed air recovery devices with a pneumatically actuated bleed control valve,

FIG. 10: shows a pneumatic diagram of a compressed air supply system,

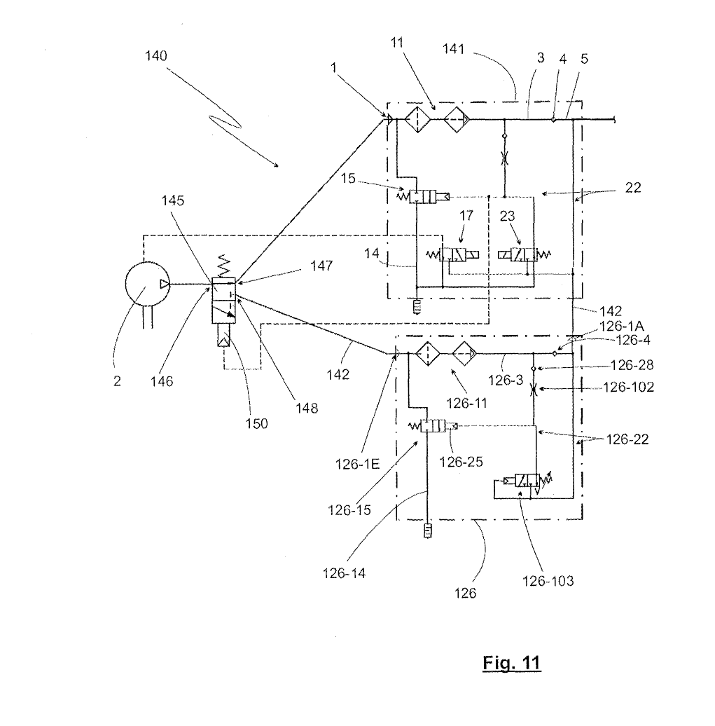

FIG. 11: shows a pneumatic diagram of a compressed air recovery device with an additional recovery module,

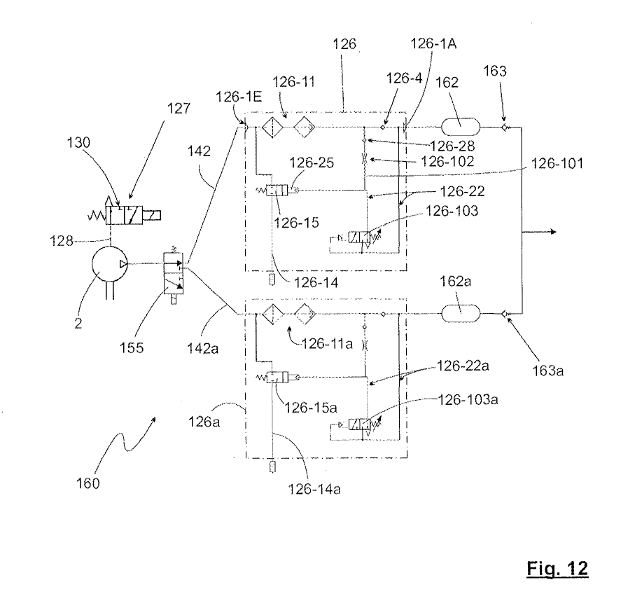

FIG. 12: shows a pneumatic diagram of a compressed air recovery device with recovery modules arranged in parallel,

FIG. 13 shows a graph of the progression of system pressure during operation of a compressed air recovery device according to FIG. 8, 9 or 10,

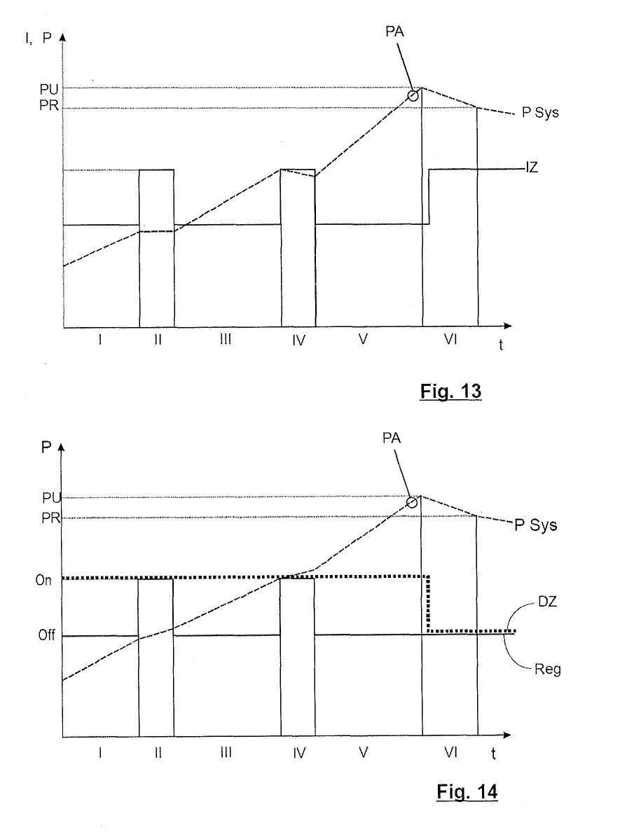

FIG. 14: shows a graph of the progression of system pressure in the case of a compressed air recovery device according to FIG. 11, and

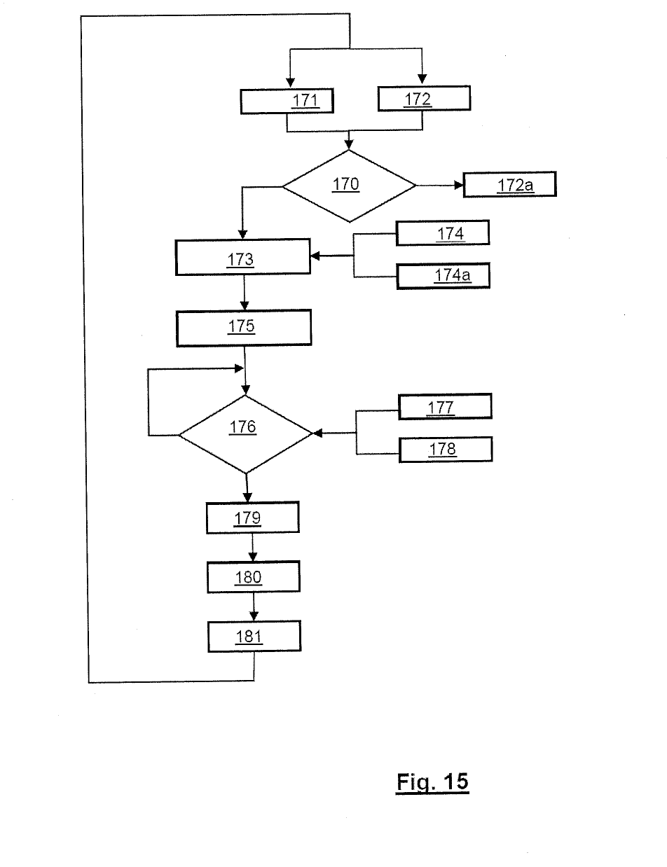

FIG. 15 shows a flow diagram of an operating method of a compressed air supply system.

FIGS. 1 to 9 each show compressed air recovery devices, in which compressed air is recovered for the supply of compressed air consumer circuits of a vehicle.

Like reference signs are used in the drawings for like or corresponding elements.

The basic construction common to all exemplary embodiments will be explained first hereinafter. The individual figures will then be used as a basis to explain the specific details of the exemplary embodiment represented by the respective figure.

The compressed air recovery devices each have a compressed air inlet 1, to which a compressor 2 can be connected. A pressure line 3 is connected to the compressed air inlet 1. A system pressure line 5 is connected to the pressure line 3 via a check valve 4. A multi-circuit protection valve 6 (see FIG. 10) can be connected to the system pressure line 5. Individual compressed air consumer circuits 7, 8, 9, 10, such as the compressed air braking circuits of a motor vehicle, are supplied via the multi-circuit protection valve 6.

A drying device 11 is arranged in the pressure line 3 and comprises a filter 12 and a separator 13 in all exemplary embodiments shown here. However, the drying device 11 can also be formed merely from a filter or may have other devices for treating the compressed air flowing through. The drying device 11 removes vapor and dirt particles from the compressed air fed from the compressor 2.

A bleed line 14, in which a pneumatically actuatable bleed valve 15 is arranged, branches off from the pressure line 3 between the compressed air inlet 1 and the drying device 11. The bleed line 14 leads out from the compressed air recovery device in each of the shown exemplary embodiments and can be connected to a bleed device, which is represented here by a sound damper 16.

Each of the compressed air recovery devices according to the exemplary embodiments of FIGS. 1 to 9 has an electrically actuatable feed control valve 17. The feed control valve 17 is formed as a 3/2 valve, of which the supply connector 18 is connected to the system pressure line 5. Alternatively to each electrically actuatable solenoid valve of the compressed air recovery device, a combination of pneumatic 3/2 valves having an electric pilot valve may be provided, wherein the pilot valve connects the system pressure line to the control inlet of the pneumatic valve when actuated.

A bleed connector 19 of the feed control valve 17 is connected to the bleed line 14 in the exemplary embodiments, but can also discharge directly into the ambient air. A compressor control line 21 is connected to a service connector 20 of the feed control valve 17. A service connector is understood hereinafter to mean the connector of a directional valve to which the device to be controlled by the respective valve is connected and which can be connected to the at least one further connector of the respective valve. In the 3/2 valve, the service connector 20 can be connected alternatively to the supply connector 18 or to the bleed connector 19.

The compressed air feed from the compressor 2 to the compressed air inlet 1 can be controlled directly via the compressor control line 21. To this end, the compressor control line 21 acts on a pressure-actuatable feed control element. The feed control element may be a pressure-actuatable control switch of the compressor 2, which switches off the compressor 2 with pneumatic control via the compressor control line 21, for example via a coupling. Alternatively, a switchable control outlet of the compressor can be provided as a pressure-actuatable control element and discharges the compressor flow released by the compressor 2 upon actuation by the compressor control line.

In the basic position, in which it is not energized, the feed control valve 17 is located in a switch position, in which the compressor control line 21 is connected to the bleed line 14. To switch off the compressed air feed, a corresponding electric signal is fed to the feed control valve 17. When energized, the feed control valve 17 changes into a switch position, in which its service connected 20 is connected to the supply connector 18 and therefore the system pressure from the system pressure line 5 is connected into the compressor control line 21 and therefore is ultimately connected to switch off the compressor 2.

To regenerate the drying device 11 when necessary, a regeneration path 22 is provided, which is connectable to the system pressure line 5 depending on the switch position of the bleed control valve 23 and discharges between the drying device 11 and the check valve 4 into the pressure line 3. Instead of being connected to the system pressure line 5, the regeneration path 22 may be connected to a line connected to the system pressure line 5, in particular a compressed air consumer circuit, if dry air is to be guided back through the regeneration path to the drying device. In the exemplary embodiments according to FIG. 1 and FIG. 2 and FIG. 8 and FIG. 9, the bleed control valve 23 is arranged in the regeneration path 22 and directly determines whether the regeneration path 22 is open by means of its switch position. In the exemplary embodiments according to FIGS. 3 to 7, the bleed control valve controls a regeneration valve arrangement in the regeneration path via its switch position so that the release of the regeneration path depends on the switch position of the bleed control valve 23.

The bleed control valve 23 is a 3/2 valve, of which the service connector 24 is connected to the pneumatic control inlet 25 of the bleed valve 15. A supply connector 26 of the bleed control valve 23 is connected to the system pressure line 5 via a supply line 5a, and a bleed connector 27 of the bleed control valve 23 is connected to the bleed line 14. The same pressure as in the system pressure line 5 always prevails in the supply line 5a. The pneumatic relationship is highlighted by the comparable reference signs of the system pressure line 5 and of the supply line 5a. By actuating the bleed control valve 23, the control inlet 25 of the bleed valve 15 can be connected to the system pressure line 5 in all the exemplary embodiments so that the bleed line 14 is released. In the cold mode of the compressed air recovery device, hot compressed air can then be forwarded through the bleed valve as the compressor 2 runs. The undesired flowing of air through the regeneration path 22 in the direction of the system pressure line 5 or towards the bleed line 14 via the unactuated bleed control valve 23 is prevented by a locking device, for example a check valve 28.

Alternatively to the connection via the supply line 5a, the supply connectors 26 and 19 of the feed control valve 17 and of the bleed control valve 23 can also be supplied via one of the compressed air consumer circuits 7, 8, 9, 10 (FIG. 10), in which a pressure representative of the system pressure prevails.

The opening of the regeneration path 22 is linked in the exemplary embodiments according to FIGS. 1 to 7 both to the position of the bleed control valve 23 and to the switch position of the feed control valve 17. It is thus ensured that the entire passage cross-section of the regeneration path 22 is only released in the regeneration mode when a flow through the regeneration path in the direction of the drying device 11 is desired. An undesired reduction in pressure in the system pressure line and downstream compressed air containers caused by compressed air flowing off in operating modes other than the regeneration mode is thus counteracted.

The bleed control valve 23 is an electrically actuatable solenoid valve 29 in the exemplary embodiments of a compressed air recovery device according to FIGS. 1 to 7. The bleed control valve 23 and the feed control valve 17 therefore can be controlled in a precise and coordinated manner by an electronic control unit similar to the control unit 122 according to FIG. 10 by means of the respective electrical control signals provided.

A compressed air recovery device 30 is illustrated in FIG. 1, in which the regeneration path comprises a regeneration pressure line 31 connected to the bleed control valve 23, and a parallel line 32 connected to the feed control valve 17. A first baffle 33 is arranged in the regeneration pressure line 31, which is connected to the service connector 24 of the bleed control valve 23, and a second baffle 34 is arranged in the parallel line 32. The control inlet 25 of the bleed valve 15 is linked between the first baffle 33 and the bleed control valve 23 to the regeneration pressure line 31 so that the first baffle 33 can build up a dynamic pressure, with which the control inlet 25 can be switched with the greatest possible pressure and therefore immediately.

A check valve 28, 28a is arranged both in the regeneration pressure line 31 and in the parallel line 32, said valves preventing an undesired return flow, both in the regeneration pressure line 31 and in the parallel line 32.

The regeneration path 22 is divided over two parallel lines, namely the regeneration pressure line 31 and the parallel line 32, which are controlled independently of one another by solenoid valves, namely the bleed control valve 23 and the feed control valve 17. It is therefore possible, in regeneration mode, to release a large passage cross-section of the regeneration path 22 by actuation both of the bleed control valve 23 and the feed control valve 17, and to thus forward a strong regeneration airflow through the drying device 11. A partial flow, which is small compared to the total volume, flows through each of the parallel line branches of the regeneration path 22, whereby small and therefore cost-effective solenoid valves can be used for the bleed control valve 23 and the feed control valve 17.

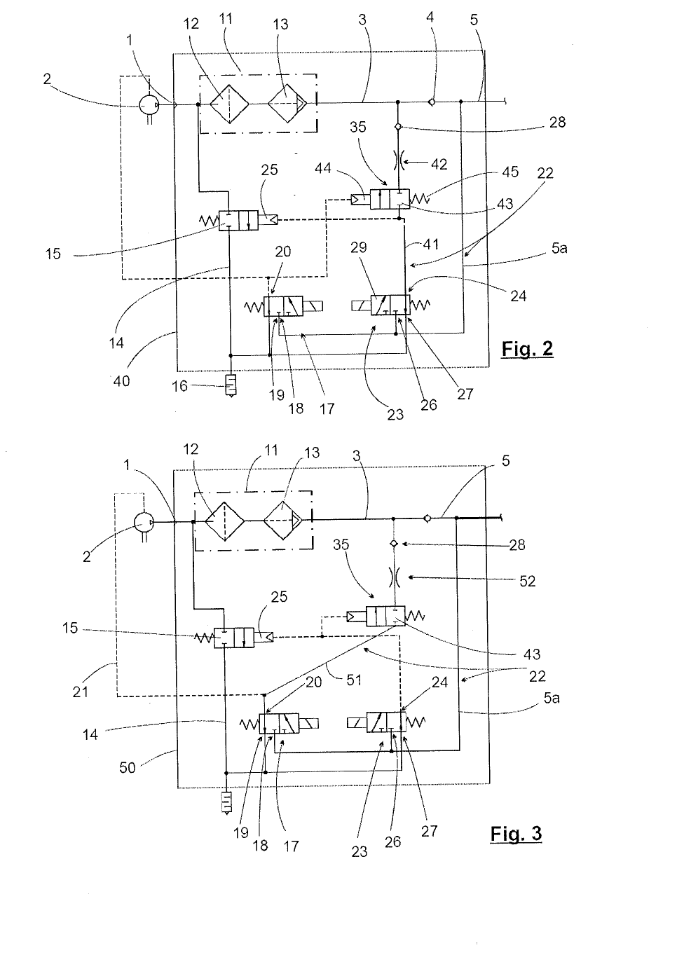

Exemplary embodiments of compressed air recovery devices are shown in FIGS. 2 to 7, in which the regeneration path 22 can be released only by cumulative actuation both of the bleed control valve 23 and of the feed control valve 17 in regeneration mode. Only if the switch positions of the feed control valve 17 and off the bleed control valve 23 provided for the regeneration mode are present at the same time will the regeneration path be released, said regeneration path remaining closed if the feed control valve 17, or the bleed control valve 23, or both valves remain unactuated. In the exemplary embodiments of FIGS. 2 to 4, either the feed control valve 17 or the bleed control valve 23 and a regeneration valve arrangement 35 are arranged in the regeneration path 22 to form an “and link” of the bleed control valve 23 and of the feed control valve 17 in the regeneration mode. The respective other solenoid valve, not arranged in the regeneration path 22, that is to say either the bleed control valve 23 or the feed control valve 17, is connected to the regeneration valve arrangement 35 so as to control the regeneration valve arrangement 35.

FIG. 2 shows a compressed air control device 40, in which a regeneration pressure line 41 connected to the bleed control valve 23 is part of the regeneration path 22. The regeneration part 22, which constitutes a bypass to the check valve 4 at the pressure line 3, is formed in a first portion by the supply line 5a, to which the bleed control valve 23 is connected. A second portion of the regeneration path 22 is formed by the regeneration pressure line 41. The check valve 28 of the regeneration path 22 and a baffle 42 are arranged in the regeneration pressure line 41.

The regeneration valve arrangement 35 is arranged in a portion of the regeneration pressure line 41 between the discharge into the pressure line 3 and the link of the control inlet 25 of the bleed valve 15. The regeneration valve arrangement 35 is a pneumatically actuatable regeneration valve 43 in the present exemplary embodiment, of which the control inlet 44 is linked to the service connector 20 of the feed control valve 17. The regeneration valve 43 is a 2/2 valve, which holds the regeneration path 22 closed in the unactuated state. As soon as the control inlet 44 is connected to the supply line 5a and then to the system pressure line 5 upon actuation of the feed control valve 17, the regeneration valve 43 changes its switch position and releases the regeneration part 22. As soon as the feed control valve 17 is no longer supplied with an electric control signal, and therefore changes its switch position and bleeds the compressor control line 21, the pneumatic switch signal at the control inlet 44 of the regeneration valve 43 is also interrupted and the regeneration valve 43 changes the switch state due to the restoring force of its valve spring 45.

The regeneration path 22 is therefore only released if the bleed control valve 23 and the feed control valve 17 are actuated simultaneously. Only then do the bleed control valve 23 and the feed control valve 17 jointly actuate the regeneration valve arrangement 35.

In the compressed air recovery device 40, the feed control valve 17 is provided exclusively as a switch for the pneumatic actuation of the compressor 2 and also of the regeneration valve arrangement 35. A permanent flow of air through the feed control valve 17, which is used for regeneration, is not provided in any operating mode of the compressed air recovery device 40. The feed control valve 17 is exclusively arranged for the transfer of pneumatic switch signals. Since there is practically no volume throughput with the feed control valve 17, solenoid valves having a relatively small opening cross-section and relatively weak valve springs are sufficient to ensure the function of the feed control valve 17. Small and cost-effective solenoid valves can therefore be used as a feed control valve 17.

FIG. 3 shows a compressed air recovery device 50 comprising an electrically actuatable feed control valve 17 and a likewise electrically actuatable bleed control valve 23, wherein the feed control valve 17 lies in the regeneration path 22. The regeneration path 22 is formed in a first portion by the supply line 5a connected to the feed control valve 17. The second portion of the regeneration path is formed by a regeneration pressure line 51, which connects the service connector of the feed control valve 17 to the pressure line 3. Similarly to the arrangement already described, the check valve 28 of the regeneration path 22 and a baffle 52 are arranged in the regeneration pressure line 51.

The regeneration valve arrangement 35, which is also formed in this exemplary embodiment by a pneumatically actuatable solenoid valve 43, as already described with reference to FIG. 2, is provided in the regeneration pressure line 51. So as to distinguish between the exemplary embodiment according to FIG. 2, the control inlet 44 of the solenoid valve 43 is connected to the bleed control valve 23 in the compressed air recovery device 50 according to FIG. 3. The bleed control valve 23 therefore switches simultaneously the bleed valve 15 and the regeneration valve arrangement 35, whereby the regeneration path 22 and the bleed line 15 are released practically simultaneously. Since none of the operating modes of the compressed air recovery device 50 requires an effective throughput in the bleed control valve 23, and instead the bleed control valve 23 is merely used for pneumatic switching, small and cost-effective solenoid valves can be used as a bleed control valve 23. In contrast to known arrangements, no pressure can therefore escape, even if an untight pressure line is provided between the compressor and the compressed air recovery device.

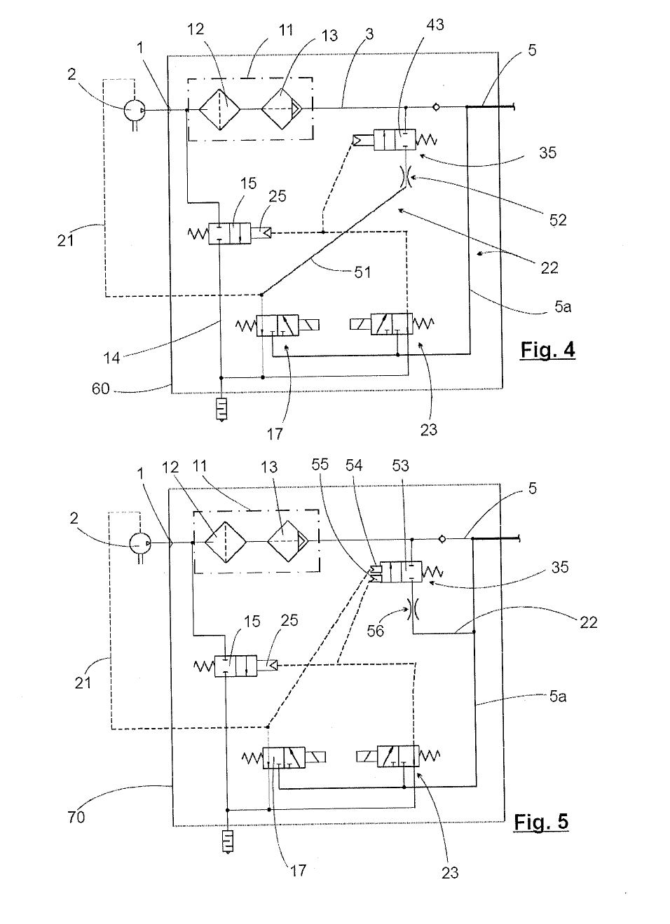

FIG. 4 shows a compressed air recovery device 60, which corresponds to the exemplary embodiment of FIG. 3, apart from the following differences. In addition to the regeneration valve arrangement 35, the feed control valve 17 is also arranged in the regeneration path 22 in the compressed air recovery device 60. The bleed control valve 23 is used for pneumatic actuation of the bleed valve 15 and also of the regeneration valve arrangement 35. In contrast to the exemplary embodiment according to FIG. 3, the compressed air recovery device 60 does not have a check valve in the regeneration path 22. FIG. 4 shows by way of example that a check valve may optionally be arranged in the regeneration path 22, but is not necessary in many applications. The function of blocking the regeneration path against undesired throughflow in the conveying mode is performed by the regeneration valve arrangement 35 in the compressed air recovery device 60.

If the bleed control valve 23 is actuated and therefore opens the bleed valve 15, the pressure line 3 is thus also depressurized and there is no return flow against the desired direction of flow in the regeneration path 22. If, by contrast, the bleed control valve 23 is not actuated and the regeneration valve arrangement 35 therefore also is not actuated, the regeneration path 22 in the regeneration valve arrangement 35 is interrupted so that no return flow can occur against the desired direction of flow in the regeneration path 22, even in this switch position. A check valve in the regeneration path is therefore generally not necessary and is instead optional in the exemplary embodiments of compressed air recovery devices comprising a regeneration valve arrangement in the regeneration path.

FIGS. 5 to 7 show compressed air recovery devices, in which only the regeneration valve arrangement 35 is arranged in the regeneration path 22 in each case and both the feed control valve 17 and the bleed control valve 23 are provided outside the regeneration path 22. Both the feed control valve 17 and the bleed control valve 23 are used exclusively for pneumatic control tasks. The feed control valve 17 and the bleed control valve 23 can therefore be small and therefore cost-effective solenoid valves.

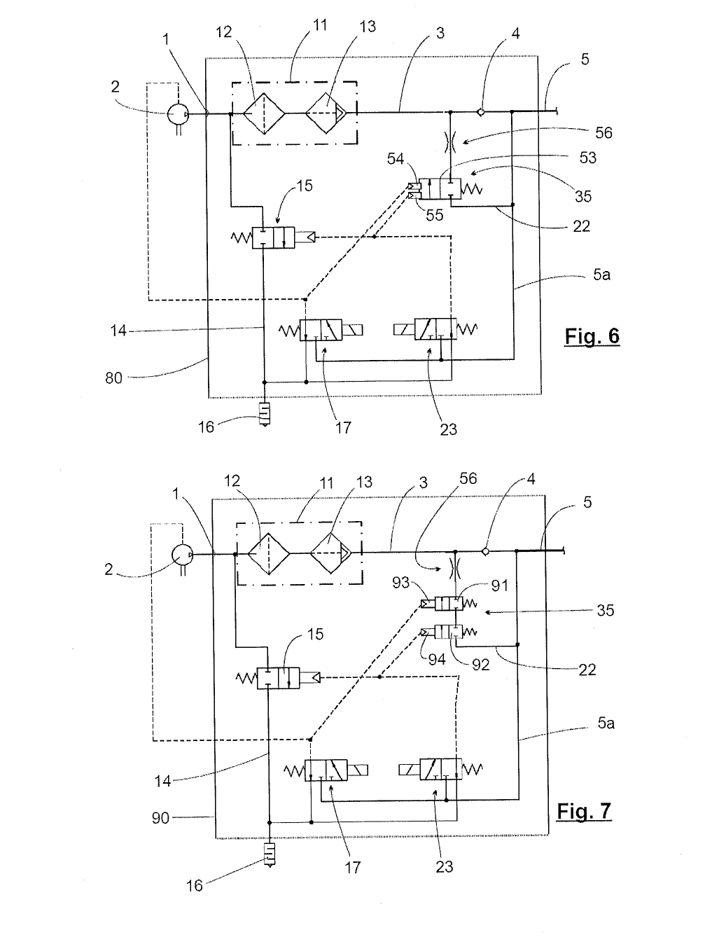

In the exemplary embodiments according to FIGS. 5 and 6, the regeneration valve arrangement 35 in the regeneration path 22 is a regeneration valve 53 formed as a 2/2 valve and having two pneumatic control inlets 54, 55. The regeneration valve 53 is arranged, in an unactuated state, in a switch position in which the regeneration valve 53 is not open and therefore the regeneration path 22 is blocked. The regeneration valve 53 only changes the switch position against the restoring force of a valve spring if the necessary control pressure is applied to both pneumatic control inlets 54, 55. The control inlet 54 is connected to the feed control valve 17, and the control inlet 55 is connected to the bleed control valve 23. The control inlets 54, 55 are designed in such a way that neither of the control inlets 54, 55 alone can overcome the restoring force of the valve spring. Only with the simultaneous actuation of the feed control valve 17 and of the bleed control valve 23, and therefore actuation of both control inlets 54, 55 of the regeneration valve 53, is the regeneration path 22 released.

A baffle 56 is arranged in the regeneration path 22 in addition to the regeneration valve 53, which forms the regeneration valve arrangement 35. In the compressed air recovery device 70 according to FIG. 5, the regeneration valve 53 is arranged closer to the pressure line 3 than the baffle 56.

As shown by the exemplary embodiment of a compressed air recovery device 80 according to FIG. 6 and alternatively to the arrangement according to FIG. 5, the baffle 56 can be positioned in the regeneration path 22 so as to be closer to the pressure line 3 than the 2/2 valve. In further exemplary embodiments (not shown), the baffles are integrated in the valves of the regeneration valve arrangement 35.

FIG. 7 shows a compressed air recovery device 98, in which, in contrast to the exemplary embodiments of FIGS. 5 and 6, the regeneration valve arrangement 35 is formed by a first regeneration valve 99 with a control inlet 93 and by a second regeneration valve 92, connected in series, with a control inlet 94. The control inlet 93 of the first regeneration valve 91 is connected to the feed control valve 17, and the control inlet 94 of the second regeneration valve 92 is connected to the bleed control valve 13. The baffle 56 and the regeneration valves 91, 92 can be arranged in a different sequence to largely like effect.

A compressed air recovery device 100 is illustrated in FIG. 8, in which the bleed control valve 23 is arranged in the regeneration path 22. The regeneration path 22 consists in its first portion of the supply line 5a and in its second portion of a regeneration pressure line 101, which is connected to a service connector 24 of the bleed control valve 23 and also discharges into the pressure line 3. The check valve 28 of the regeneration part 22 and a baffle 102 are arranged in the regeneration pressure line 101 in the manner already described. The bleed valve 15 is connected via its control inlet 25 to the regeneration pressure line 101 and is thus controlled by the bleed control valve 23.

In contrast to the exemplary embodiments of FIGS. 1 to 7, the bleed control valve 23 is a pneumatically actuatable governor valve 103. The governor valve 103 is a 3/2 valve, of which the pneumatic control inlet 104 is connected to the supply line 5a. The function according to the embodiments of the invention is provided when the pneumatic control inlet 104 is controlled by a pressure signal corresponding to the system pressure. Due to the connection to the supply line 5a, the system pressure, which prevails in the system pressure line 5, is constantly applied to the control inlet 104 of the governor valve 103. Alternatively, the pneumatic control inlet 104 can therefore also be connected to one of the compressed air consumer circuits 7, 8, 10 (see FIG. 10) which are not pressure-limited. In the first shown switch position of the governor valve 103, the regeneration pressure line 101 is connected to the bleed connector 27 of the governor valve 103 and the regeneration path 22 is therefore closed. The bleed connector 27 of the governor valve 103 is connected to the bleed line 14 in the present exemplary embodiment.

As soon as the system pressure reaches the switch pressure of the governor valve 103, at which the control force produced by the system pressure at the control inlet 104 is strong enough to overcome the valve spring 105 of the governor valve 103, the governor valve 103 automatically changes into the second switch position, in which the regeneration pressure line 101 is connected to the supply line 5a and therefore to the system pressure line 5. The valve spring 105 is adjustable, and therefore the switch pressure of the governor valve 103 is adjustable via the spring force of the valve spring 105.

In the second switch position when the governor valve 103 is actuated, the system pressure is connected to the control inlet 25 of the bleed valve 15, and the bleed line 14 is thus released. The regeneration mode is initiated in this switch state of the compressed air recovery device 100. Dry system air flows through the regeneration path 2 via the pressure line and against the direction of flow in the conveying mode, through the drying device 11, and ultimately flows off via the bleed line 14. As soon as the system pressure falls below a switch-back pressure, the valve spring moves the governor valve 103 automatically back into the first switch position. The regeneration path 22 is thus closed so that a further return flow to the drying device 11 is prevented. The switch-back pressure is determined by the switch pressure in relation to a specific pressure hysteresis, which is determined by the properties of the governor valve.

The feed control valve 17 is an electrically actuatable 3/2 valve, which, via a compressor control line 21 to the compressor 2, controls the compressed air feed by switching the compressor on and off.

FIG. 9 shows a compressed air recovery device 110, which, apart from the following differences, corresponds to the compressed air recovery device 100 according to FIG. 8, that is, it has a pressure-controlled governor valve 103 as a bleed control valve 23.

The feed control valve 17 of the compressed air recovery device 110 is connected via its bleed connector 19 to the regeneration pressure line 101 of the governor valve 103. Pressure can thus be applied to the compressor control line 21 to the compressor by the electric feed control valve 17 by bringing the feed control valve 17 into its second switch position by actuation and thus connecting the compressor control line 21 directly to the supply line 5a. The compressed air feed can also be switched off by the governor valve 103 in the first switch position of the feed control valve 17. As soon as the governor valve 103 changes its switch position and opens the regeneration path after reaching the switch pressure, the compressor control line 21 is also vented.

A much more cost effective valve can also be used as a bleed control valve 23 with a governor valve 103 controlled in a pressure-dependent manner instead of a conventional electric bleed control valve at full control capacity of all operating modes.

In further exemplary embodiments (not illustrated), a compressed air recovery devices similar to FIG. 1 to FIG. 7 are provided, in which a governor valve controlled in a pressure-dependent manner is provided instead of an electrically actuatable solenoid valve.

The operating method of the compressed air recovery devices 100, 110 according to FIGS. 8 and 9 will be explained hereinafter on the basis of the graph in FIG. 13. In the graph according to FIG. 13, the temporal progression of the electric actuation signal IZ for the feed control valve 17 is illustrated as a solid line, and the temporal progression of the system pressure P SYS of the system pressure in the system pressure line 5 is illustrated as a dashed curve.

In a first interval I (FIG. 13), the compressed air recovery device is in a conveying mode, in which the compressed air fed from the compressor 2 is conveyed via the pressure line 3 into the system pressure line 5, where it is made available for the compressed air consumer circuits. The compressed air is guided via the drying device 11 arranged in the pressure line 3. In the conveying mode according to interval I, no electric actuation signal IZ is fed to the feed control valve 17, and therefore the compressor functions and delivers a compressed air flow into the pressure line 3.

The second interval II (FIG. 13) corresponds to an idle mode, wherein an electric signal IZ is fed to the feed control valve 17 and the compressor is thus switched off. If none of the connected consumer circuits requires compressed air, the system pressure P SYS remains at a constant level, as illustrated in the second interval II. As soon as the actuation current IZ for the feed control valve is switched off again, the compressed air recovery device again changes to conveying mode. The system pressure P SYS increases further, as illustrated in the third interval III. For the fourth interval IV, the compressed air recovery device again changes to idle mode, wherein, in the situation illustrated by way of example, one or more compressed air consumer circuits require compressed air and the system pressure P SYS thus falls.

The conveying mode and the idle mode are sub-modes of a normal operating mode of the compressed air recovery device, which is interrupted when there is a corresponding request for phase with regeneration mode. The control of the normal operating mode, that is to say the change between conveying mode and idle mode by switching the compressed air feed on and off, is preferably dependent on the travelling situation of a vehicle equipped with the compressed air recovery device. A conveying mode with compressed air delivery, that is to say the compressor is switched on, is preferably provided if the vehicle is in a thrust phase and is not under load, for example approaching a red traffic light. In such thrust operating phases, the energy of the travelling vehicle can be used for operation of the compressor, and compressed air can be provided by energy recovery from the kinetic energy of the vehicle (recuperation), without the use of fuel.

In operating phases of the vehicle at high load, the compressor is to be switched off where possible and the compressed air recovery device is to be operated in the idle mode (intervals II and IV), since a disproportionately high energy expenditure is required in these operating phases for the compressed air feed compared to the thrust operating phases. The bleed valve 15 and therefore the bleed line 14 are kept closed in the operating phases in which the compressor is switched off without simultaneous regeneration, and therefore the pressure in the pressure line 3 and in the drying device 11 remains practically constant. When the compressor 2 is switched on again, the system pressure, which prevails at this moment in the system pressure line 5, is thus reached again almost immediately and compressed air is delivered into the system pressure line 5.

In the graph according to FIG. 13, a thrust operating phase of the vehicle and corresponding conveying mode are again present in the fifth interval V in accordance with the above explanations, wherein the system pressure P SYS increases as a result of the further compressed air feed of the compressor. However, as soon as the system pressure P SYS reaches the switch pressure PU of the governor valve 103 (FIGS. 8 and 9), the governor valve 103 changes its switch position and releases the regeneration path 22. The compressed air recovery device is thus changed to the regeneration operating mode, wherein the governor valve 103 also releases the bleed line 14 by actuation of the bleed valve 15. In regeneration mode, which is illustrated in the graph according to FIG. 13 as a sixth interval VI, compressed air from the system pressure line 5 flows through the regeneration path 22 and the drying device 11, and ultimately flows off through the bleed line 14, whereby the system pressure P SYS temporarily decreases in the system pressure line 5. As soon as a control unit identifies the switch of the governor valve and the opening of the regeneration path caused thereby and which is still to be described, the electric actuation signal IZ is fed to the feed control valve 17. The feed control valve 17 accordingly switches off the compressor 2 and therefore the further compressed air feed, and therefore the energy consumption of the compressor in the sixth interval VI is minimized.

During normal operation, the compressed air recovery device therefore can be operated with intelligent utilization of the thrust operating phases by switching the compressed air feed on and off. A suitable pressure band is predetermined for a control unit, which generates the actuation signal IZ for the feed control valve. A switch-off value PA for the system pressure is provided, and, when reached, the compressed air feed is interrupted if regeneration is not desired. The switch-off pressure PA is lower than the switch pressure PU of the bleed control valve formed as a governor valve 103. The switch-off pressure PA preferably lies within the pressure window which is determined by the switch pressure PU and the switch-back pressure PR of the governor valve 103. It is thus ensured that a further increase in pressure and therefore a switching of the governor valve 103 are inhibited when the system pressure approaches the switch pressure. In addition, the greatest possible pressure band is provided for pressure control in the conveying mode. For example, if the switch pressure PU of the governor valve lies at 12.5 bar, the pressure band for the conveying mode may lie at approximately 8 to 12.3 bar.

Selective initiation of the regeneration mode is possible at any time by maintaining the compressed air feed until the system pressure P SYS exceeds the switch pressure PU and opens the governor valve and initiates the regeneration mode. To initiate the regeneration mode, the feed control valve forms a switch, which is used by a control unit if, on the basis of detailed measured values and corresponding evaluation, regeneration of the drying device 11 is desired. Regeneration of the drying device is thus possible at any possible pressure level in the system pressure line by raising the system pressure P SYS above the switch pressure of the governor valve by selectively maintaining the compressed air feed.

In the regeneration mode of the compressed air recovery device, the control unit prompts the switching off of the compressor and therefore of the compressed air feed as soon as the system pressure P SYS exceeds the switch pressure of the governor valve 103. The switch state of the governor valve 103 is evaluated, and the compressed air feed is interrupted if a change to the switch state due to the fact that the switch pressure PU has been exceeded is identified. The control unit 122 identifies the switch state of the bleed control valve, formed as a governor valve 103, from ongoing measurements of a pressure value representative of the system pressure (P SYS). In order to determine the system pressure P SYS or a pressure representative of the system pressure in one of the compressed air consumer circuits, pressure sensors which are yet to be explained in greater detail on the basis of FIG. 10 and which are connected to the control unit for signal transfer are provided. An electric sensor may alternatively be used.

To initiate the cold mode, the system pressure P SYS is increased by further compressed air feed, in accordance with the procedure in the regeneration mode, until the governor valve 103 changes the switch position and therefore releases the bleed line 14 by actuation of the bleed valve 15. In contrast to the regeneration mode, the compressor 2 is not switched off in the cold mode, and therefore hot air from the compressor 2 is forwarded through the bleed line, and icing is prevented. In order to determine the presence of a risk of icing, suitable temperature sensors may be assigned to the control unit.

If predetermined operating states of the vehicle are present, the need for manually initiated regeneration is displayed to a driver, for example by a signal lamp provided for this purpose in the driver's cabin of a vehicle. Such an operating state for manually initiated regeneration is provided in particular at standstill of the vehicle when, in a cold environment, there is a particular risk of icing of the moisture in the drying device. If there is a risk of icing, a signal is indicated to the driver when the vehicle is parked and the ignition is switched off, said signal indicating the need for manually initiated regeneration. The request for regeneration at standstill when the engine is running can be made by the driver by means of a separate button or by means of the combination of existing inlet media, such as an acceleration pedal, clutch, and brakes. If a manual regeneration request is identified, the feed control valve 17 is brought into its first switch position by switching on the compressor and maintaining the compressed air feed until the switch pressure PU has been reached. In a preferred embodiment, in the case of a manual regeneration request at standstill of the vehicle, a higher speed of the engine, which drives the compressor, is simultaneously requested via data communication until the switch pressure of the governor valve is reached.

The switch pressure PU and the switch-back pressure PR determine the phase in which the governor valve 103 releases the regeneration path 22. The switch pressure PU and the switch-back pressure PR can be adjusted by a valve spring of the governor valve 103 and are selected such that a desired air volume flows through the regeneration path 22. The governor valve 103 is adjusted in such a way that the air volume takes on the moisture received in the drying device. The control unit determines the volume of moisture received by the drying device and requests the regeneration mode when the received volume of moisture corresponds to the volume of air which can be regenerated. In the exemplary embodiment, a moisture sensor is provided for determination of the moisture in the drying device. Alternatively, the volume of moisture is estimated by the conveyed air volume.

When evaluating the received volume of moisture to request the regeneration mode by raising the system pressure, the control unit preferably considers a prognosis, as a result of corresponding programming, of the additional volume of moisture which will be introduced, together with the air also flowing through the drying unit, before the switch pressure PU is reached. The current or average compressed air consumption of the vehicle over time can be considered in order to precisely determine a time window until the switch pressure is reached and in order to precisely determine the prognosis of the volume of moisture still to be introduced until then.

Furthermore, a control unit (FIG. 10) determines the progression of pressure during the regeneration mode in the interval between switching and switching back of the bleed control valve 23 and calculates therefrom the returned air volume. If it is identified that the returned volume was not sufficient for complete regeneration, the calculated remaining volume of moisture can be taken into consideration when determining the moment in time for the next regeneration process. The volume of air actually used for regeneration is thus measured during the regeneration process so as to possibly compensate for inadequate regeneration in subsequent regeneration phases.

A compressed air supply system 120 for a vehicle is illustrated in FIG. 10 and has a compressor 2, a compressed air recovery device 121, a multi-circuit protection valve 6, and an electronic control unit 122 for generating electric valve control signals.

The compressor 2 is connected to a compressed air inlet 126-1E of a recovery module 126, which is part of the compressed air recovery device 121. A multi-circuit protection valve 6 is connected to the compressed air recovery device 121 and supplies four compressed air consumer circuits. In the present exemplary embodiment, two service breaking circuits 7, 8 of the vehicle, a trailer pressure circuit 9 and an additional consumer pressure circuit 10 are provided as compressed air consumer circuits for connection of any pneumatic consumer. An overflow valve 124, 124a, 124b, 124c is provided in each of the compressed air consumer circuits 7, 8, 9, 10, wherein the compressed air consumer circuit 9 for the trailer is additionally equipped with a pressure-limiting valve 125.

The compressed air recovery device 121, the multi-circuit protection valve 6, and the control unit 122 are formed as modular assemblies, as will be described in greater detail hereinafter.

The compressed air recovery device 121 is arranged in a recovery module 126, with the exception of a feed control valve 127. The recovery module 126 is a modular assembly, which has the pneumatic elements of the compressed air recovery device, of which the electric feed control valve is arranged outside the recovery module 126. The recovery module 126 may correspond, in terms of the connection of the pneumatic elements, to one of the exemplary embodiments of compressed air recovery device according to FIG. 1 to FIG. 9, wherein the electric feed control valve provided in each of those cases is arranged outside the recovery module. In exemplary embodiments with electrically actuated bleed control valves, the bleed control valve would be formed as a pneumatically actuated governor valve in a corresponding arrangement in a recovery module.

In the shown installed state of the recovery module 126, the compressor 2 of the compressed air supply system is connected to a compressed air inlet 126-1E of the recovery module 126. A pressure line 126-3 of the recovery module 126 is connected to the compressed air inlet 126-1E. A system pressure line 126-5 is connected to the pressure line 126-3 via a check valve 126-4 and leads to a compressed air outlet 126-1A of the recovery module 126. A drying device 126-11 is arranged in the pressure line 126-3, wherein a bleed line 126-14 branches off from the pressure line 126-3 between the compressed air inlet 126-1E and the drying device 126-11. A pneumatically actuatable bleed valve 126-15 is arranged in the bleed line 126-14. A regeneration path 126-22, which discharges between the drying device 126-11 and the check valve 126-4 into the pressure line 126-3, branches off from the system pressure line 126-5. A bleed control valve in the regeneration path 126-22 is formed as a pneumatically actuatable governor valve 126-103, which can be controlled constantly by the system pressure in the system pressure line 126-5.

A control inlet 126-25 of the bleed valve 126-15 is connected to a regeneration pressure line 126-101, which forms the portion of the regeneration path 126-22, controlled by the governor valve 126-103, between the governor valve 126-103 and the pressure line 126-3. A check valve 126-28 and a baffle 126-102 are also arranged in the regeneration pressure line.

The multi-circuit protection valve 6 is connected to the compressed air outlet 126-1A of the recovery module 126. The connection between the compressed air outlet 126-1A and the multi-circuit protection valve 6 is part of the system pressure line 5 of the compressed air recovery device. The connection can be formed by a line, ducts, or plug-in connections.

The electrically actuatable feed control valve 127 arranged outside the recovery module 126 corresponds in terms of function and its connectors to the feed control valve 17 of the exemplary embodiments in FIG. 1 to FIG. 9. In the present exemplary embodiment, the feed control valve 127 is assigned to the compressor 2. Only a short compressor control line 128 and a cable 129 for transferring the electric actuation current from the control unit 122 for operation of the feed control valve 127 are therefore necessary. The electrically actuatable feed control valve 127 is also a 3/2 solenoid valve in this exemplary embodiment. The supply connector 130 of the feed control valve 127 is coupled to the system pressure line 5 in the present exemplary embodiment in such a way that the system pressure from the system pressure line 5 is connected to the compressor 2 via the compressor control line 128 when the feed control valve 127 is actuated by the control unit 122, and the compressed air feed is inhibited. In an exemplary embodiment (not shown), the supply connector 130 is connected to one of the compressed air consumer circuits, more specifically to a compressed air consumer circuit which is not kept at a pressure level lower than the system the pressure due to the arrangement of a pressure-limiting valve 125. Alternatively to the system pressure line 5, the feed control valve 127 can therefore be connected to one of the service brake circuits 7, 8 or to one of the compressed air consumer circuits 9, 10.

Due to the arrangement of the electrically actuatable feed control valve 127 outside the recovery module 126, the recovery module 126 can manage with exclusively pneumatic components, with no electrical supply. It is therefore a simple and cost-effective component part, which can also be used in a versatile and possibly redundant manner. A possibility for redundant arrangement of a recovery module is described later on the basis of FIG. 11. A purely pneumatic compressed air supply system can also be retrofitted in an existing vehicle having an external feed control valve 127 and a control module 131 so as to retrospectively increase the energy efficiency of the system. The multi-circuit protection valve 6 is a purely pneumatic component part in the exemplary embodiment shown, with no electric sensors or electric valves.

The control module 131 is a compact assembly, which comprises a control unit 122. The control unit 122 is assigned a signal outlet 134, via which the control unit 122 can emit electric control signals. The electric feed control valve 127 is connected to the signal outlet 134. The control module 131 thus controls the pneumatic assemblies of the recovery module 126 and of the multi-circuit protection valve 6 merely via the feed control valve 127. Control via the feed control valve 127 is implemented in accordance with the operating method described above on the basis of FIG. 8 and FIG. 9. To this end, the control module is formed in such a way that the desired operating mode of the compressed air recovery device, in particular the conveying mode, the idle mode, and the regeneration mode, can be controlled by the switching of the compressed air feed on and off by means of the feed control valve 127. The operating modes are controlled under consideration of the system pressure, which can be determined by means of pressure sensors in a manner which is yet to be described in greater detail hereinafter. In the shown exemplary embodiment, the signal outlet 134 is arranged in the region of an outer face of the control module and is connected via a signal line to the control unit inside the control module. The signal outlet 34 is thus externally accessible on the control module 131 and enables easy installation of an external feed control valve. The signal outlet 134 can also be arranged on the control unit 122, wherein an internal signal line between the signal outlet 134 and the control unit is dispensed with or is very short.

In an exemplary embodiment (not illustrated), the electrically actuatable feed control valve 127 is housed in the control module 131, which contains the electronic control unit 122. The feed control valve is connected within the control module 131 to the control unit 122 via an internal signal line, that is to say a signal line arranged within the control module 131. In the embodiment with a feed control valve 127 arranged within the control module 131, an externally accessible connector of the control module 131 is provided for connection of the compressor control line to the feed control valve 127. Of the three modular assemblies of the compressed air supply system 120, only the control module 131 is to be equipped with electrical supply with an arrangement of the feed control valve in the control module 131. The control module 131 with the feed control valve 127, or else a part of the control unit controlling the feed control valve, can be arranged structurally close to the compressor. In a further exemplary embodiment (not illustrated) the electrically actuatable feed control valve 127 is housed in the assembly of the multi-circuit protection valve.

As already described above, the control of the compressed air supply system is based on the system pressure, in such a way that a conveying mode, a regeneration mode, and a cold mode can be controlled via the switching of the compressed air feed on and off. The assembly of the multi-circuit protection valve 6 and the control module 131 are combined independently of the compressed air recovery device so that a recovery module can be easily replaced.

The control module 131, which contains the control unit 122, can be fitted on the assembly of the multi-circuit protection valve 6 and has continuous line portions of the compressed air consumer circuits. The respective devices of the compressed air consumer circuits are connected to the control module 131.

A pressure sensor 132, 132a, 132b, 132c is arranged in each of the line portions of the compressed air consumer circuits 7, 8, 9, 10 and is connected in each case to the control unit 122. The control unit 122 utilizes the measured value of the pressure sensor 132 in the service braking circuit 6 for the control of the compressed air feed. The pressure sensors in the other compressed air consumer circuits are utilized for the control of other systems of the vehicle and are therefore illustrated in the figure by dashed lines.

However, for the control of the compressed air feed, it may be advantageous, for the refinement of the control process, to utilize additional measured values from the compressed air consumer circuits having no pressure-limiting valve, in addition to the pressure sensor 132 in the service braking circuit 7. To this end, the measured values of the pressure sensor 132a in the service braking circuit 8 or of the pressure sensor 132c in the additional compressed air consumer circuit 10 are considered for the control of the compressed air feed.

To control the compressed air supply system 120 and possibly also further systems, signals of one or more communication buses 133, such as CAN or FlexRay, are fed to the control unit 122 and supply information regarding the dynamic behavior of the vehicle, such as engine speed, speed, and pedal positions of the vehicle. Control methods for systems, such as engine control, anti-lock braking system (ABS), electronic brake control (EBS) or traction control, electronic parking aid systems (EPH), and suspension (ECAS), can be considered in the software of the control unit 122. Additional control valves and pressure sensors, which are to be used for assistance systems, such as the electronic parking aid (EPH), can also be integrated in the control module 131.

In an exemplary embodiment (not illustrated), the bleed connector of the feed control valve 127 is linked to the portion of the regeneration path 22 controlled by the governor valve 103, similarly to the exemplary embodiments according to FIG. 9. If the feed control valve 127 is not actuated (or in the event of power failure), the compressor can thus be switched off via the governor valve 103.

FIG. 11 shows part of a compressed air supply system comprising a compressed air recovery device 140, which comprises a primary module 141, of which the design follows the basic structure of the exemplary embodiment according to FIGS. 1 to 7. The feed control valve 17 and the bleed control valve 23 are each electrically actuatable solenoid valves. The primary module 141 may correspond to any of the exemplary embodiments of compressed air recovery devices according to FIGS. 1 to 7.

The primary module 141 comprises a compressed air inlet 1, to which a compressor 2 can be connected, and a pressure line 3 connected to the compressed air inlet 1. A system pressure line 5 is connected to the pressure line 3 via a check valve 4. A drying device 11 is arranged in the pressure line 3. A bleed line 14, in which a pneumatically actuatable bleed valve 15 is arranged, branches off from the pressure line 3 between the compressed air inlet 1 and the drying device 11. A regeneration path 22 of the primary module 141 can be connected to the system pressure line 5 by the bleed control valve 23. The electrically actuatable feed control valve 17 is arranged, for control of the compressed air feed, between a compressor control line 21 to the compressor 2 and the system pressure line 5.

A recovery module 126 comprising a drying device 126-11 is provided in a parallel pressure line 142 arranged parallel to the pressure line 3. Alternatively to the pressure line, the parallel pressure line 142 can be released by a pneumatically actuatable shuttle valve 145. The shuttle valve 145 is a pneumatically actuated 3/2 valve, to the supply connector 146 of which the compressor 2 is connected. The compressed air inlet 1 and a compressed air inlet 149 of the recovery module 126 are connected to the outlet connectors 147, 148 of the shuttle valve 145. The pneumatic control inlet 150 of the shuttle valve 145 is linked to the actuation of the bleed valve 15 of the primary module 141.

As soon as the bleed control valve 23 of the primary module 141 releases the regeneration path 22 in the regeneration mode and therefore simultaneously releases the bleed line 14 via the bleed valve 15, the shuttle valve 145 changes the switch position and guides the compressed air of the compressor 2 through the recovery module 126. Compressed air recovery via the recovery module 126 can nevertheless thus be maintained, even in operating phases in which the drying device in 11 has to be regenerated.

The recovery module 126 corresponds in terms of structure to the recovery module 126 according to FIG. 10. It contains a governor valve 126-103, controlled in a pressure-dependent manner, as a control member for regeneration of its drying device 126-11. The governor valve 126-103 is arranged in a regeneration path 126-22 of the recovery module 126. The regeneration path 126-22 bypasses a check valve 126-4, which, similarly to the above-described basic structure of the primary module 141 in the parallel pressure line 142, separates a system-pressure-guiding system pressure line 126-5 from the pressure line 126-3 comprising the drying device 126-11. A bleed line 126-14 branches off between the compressed air inlet 126-1E of the recovery module 126 and the drying device 126-11. A bleed valve 126-15, which is controlled in a pressure-dependent manner and which is switched pneumatically by the governor valve 126-103, is arranged in the bleed line 126-14 of the recovery module 126. The bleed line 126-14 of the recovery module 126 can be combined with the bleed line 14 of the primary module 141 and fed for joint bleeding.

The compressed air recovery device 140 has two drying chambers due to the primary module 141 and the recovery module 126, and therefore the compressed air conveyance can be maintained practically constantly, even during regeneration of one of the drying devices. No electric component parts are required for the recovery module, and therefore the recovery module can be manufactured in a cost effective and simple manner.

The recovery module 126 can also be retrofitted with little effort by mounting in an existing compressed air supply system a pressure connector for the recovery module in the system pressure line. In a modular system, this may occur in the region of the connection between the recovery module and the multi-circuit protection valve.

The operation of the compressed air recovery device according to FIG. 11 comprising a pneumatically functioning recovery module is illustrated in the graph of FIG. 14. In the graph, the progression of the solid line corresponds to the activation state Reg of the regeneration by control of the bleed control valve. The dashed line represents the activation state DZ of the compressed air feed between the “on” and “off” states. The activation state of the compressed air feed can be influenced by the electrically actuatable feed control valve. In the state DZ=on, the feed control valve is not activated, that is to say compressed air is fed. The dashed line corresponds to the progression over time of the system pressure P SYS in the system pressure line.

The first interval I (FIG. 14) corresponds to a conveying mode, wherein the activation state DZ for the compressed air feed is “on” and the activation state Reg for the regeneration of the drying device in the primary module is “off”. If the compressor is switched on and the regeneration path is isolated, the system pressure P SYS is raised by the continuous compressed air feed. In the second interval II, the drying device is regenerated by activation of the regeneration path of the primary module (control of the bleed control valve 23), wherein the compressed air feed remains switched on. Pressure is applied to the regeneration pressure line 101, whereby the shuttle valve 145 changes into its second switch position and the compressed air from the compressor is conveyed to the system pressure line 5 via the parallel pressure line 142 and the recovery module 126 fixed there. In spite of the regeneration mode in the primary module, the compressed air feed to the compressed air consumer circuits can thus be maintained at the same time. Due to the running regeneration of the drying device of the primary module, regeneration air is removed from the system pressure line so that the increase of the system pressure P SYS in interval II is less sharp than in interval I.

In the third interval III, the activation state Reg off the regeneration is set to “off”, and therefore the switched-on compressor quickly increases the system pressure P SYS. This phase of the conveying mode is preferably initiated by the control unit in thrust phases of the vehicle at low load. In the fourth interval IV, the regeneration of the primary module of the compressed air recovery device is activated again and the compressed air flow of the compressor is guided through the parallel pressure line and the recovery module due to the simultaneous switching of the shuttle valve.

The regeneration of the drying devices in the pneumatically controlled recovery module is controlled similarly to the regeneration of the pneumatically controlled compressed air recovery device according to FIG. 8 and FIG. 9. Reference is therefore made to the description of the regeneration control on the basis of FIG. 13.

If regeneration of the drying device 126-11 of the recovery module 126 is requested, the system pressure P SYS is raised by maintaining the compressed air feed until the switch pressure PU of the governor valve 126-103 is reached in the recovery module 126. Provided regeneration of the drying device 126-11 in the recovery module 126 is not necessary, the compressed air feed is controlled within a pressure band, which is defined by a switch-off pressure PA. The switch-off pressure PA lies between the switch pressure PU and the switch-back pressure PR of the governor valve 126-103. As already described with reference to FIG. 13, if regeneration of the drying device 126-11 in the recovery module 126 is requested, the regeneration is initiated selectively by further maintaining the compressed air feed, in spite of the fact that the switch-off value PA for the compressed air feed has been reached, and therefore the system pressure P SYS reaches the switch pressure of the governor valve 126-103 in the recovery module 126.

FIG. 12 shows a compressed air recovery device 160, in which two pneumatic recovery modules 126, 126a connected in parallel and of the type already described with reference to FIGS. 10 and 11 are arranged. Each recovery module 126, 126a has a governor valve 126-103, 126-103a, which is controlled in a pressure-dependent manner and which controls a respective assigned bleed valve 126-15, 126-15a in the bleed line 126-14, 126-14a of the respective recovery module 126, 126a and opens the corresponding bleed line 126-14, 126-14a in the open switch state.

The recovery modules 126, 126a are identical in terms of construction and are activated alternatively by a shuttle valve 155. In the shown exemplary embodiment, the shuttle valve 155 is an electrically actuatable 3/2 valve and, in its switch positions, connects one of the recovery modules 126, 126a to the compressor 2. As soon as the last active recovery module is switched in the regeneration mode, the respective other recovery module 126, 126a is activated by a control device (not illustrated).

The compressed air feed is controlled via an external feed control valve 127, which, as already described with reference to FIG. 10, can be assigned structurally to the compressor 2 or to an electronic control unit (not shown).

A recovery module 126, 126a is arranged in each of the parallel pressure lines 142, 142a, which are connected to the shuttle valve 155. The drying devices 126-11, 126-11a can each be supplied via a regeneration path 126-22, 126-22a with dry air, against a direction of flow in the conveying mode. The governor valve 126-103, 126-103a of the respective recovery module 126, 126a is arranged in the regeneration path 126-22, 126-22a and is controlled by the system pressure, which prevails in the respective parallel pressure line 142, 142a, after a check valve 126-4.

The regeneration of the drying devices 126-11, 126-11a of the recovery modules 126, 126a is fed from a separate regeneration volume. The compressed air recovery device 160 has a separate regeneration store 162, 162a for each recovery module 126, 126a, said regeneration stores each being arranged in the system-pressure-guiding portions of the parallel pressure lines 142, 142a to the compressed air consumer circuits. The compressed air consumer circuits are each protected by a check valve 163, 163a in the parallel pressure lines 142, 142a. The check valves 163, 163a are arranged between the respective regeneration stores 162, 162a and the consumer circuits.

The regeneration of a drying device 126-11, 126-11a can be initiated at the end of a conveying phase by the corresponding drying device 126-11, 126-11a by raising the system pressure P SYS above the switch pressure of the governor valve 126-103, 126-103a of the relevant recovery module 126, 126a. The check valves 163, 163a prevent the governor valve 126-103, 126-103a of the respective, as yet inactive recovery module 126, 126a from switching. The regeneration is carried out until the pressure level in the respective active regeneration store 162, 162a falls below the switch-back pressure of the governor valve 126-103, 126-103a.

A possible flow diagram of a method according to an embodiment of the invention for operating a compressed air recovery device or a compressed air supply system is illustrated in FIG. 15.

In a first step 170 for deciding whether regeneration is to be requested, the control unit determines the operating state 171 of the vehicle and the volume of moisture 172 already received in the drying device. The volume of moisture 172 is measured by means of moisture sensors or is determined on the basis of the volume of conveyed air, which is measured or is taken into account as an estimated value. The volume of received moisture at 172 may also be estimated. If predetermined operating states are present, for example if the ignition is switched off, manual regeneration 172a is thus requested. To this end, a signal lamp for example is activated in the driver's cabin of the vehicle.

If an operating state for manual regeneration is not present, the initiation moment 173 for the regeneration mode is thus determined, that is to say via the expected moment at which the regeneration mode is to be initiated in view of regeneration and the switch pressure necessary therefor. To make a prognosis regarding the time window until the switch pressure is reached, the control unit utilizes the moisture volume 174 still to be received until then and an average consumption 174a of the connected compressed air consumers.

As soon as the moment arrives at which complete regeneration can take place in a timely manner with the expected pressure rise and predicted moisture uptake, the regeneration mode is initiated 175. The switch-off value for the compressed air feed is eliminated, and compressed air continues to be conveyed until the switch pressure has been exceeded.

During the rise of the system pressure, the switch state of the governor valve is determined 176. The switch position can alternatively be monitored by means of a sensor 177 assigned to the governor valve, or by means of evaluation of the rise in pressure on the basis of measurements 178 of the system pressure. Conclusions regarding the switching of the governor valve can be drawn from a decrease in the system pressure. The sensor 177 may be an electric switch, which changes the switch position with the governor valve. The signal of the sensor 177 can be read by the control unit.

As soon as the governor valve switches, the compressed air feed is switched off and the feed control valve is controlled accordingly. As soon as the switch state 176 changes again when the switch-back pressure is undershot and this event is detected, the returned air volume between switching and switching back of the governor valve is established 179. The remaining moisture volume 180 is used as a starting moisture value 181 for subsequent determinations of regeneration times. The starting moisture value 181 therefore replaces, for subsequent calculation processes, the value which was previously taken into account at the start of the procedure as the moisture volume 172 received in the drying device.

The approach illustrated on the basis of FIG. 15 during operation of a compressed air recovery device and the control of the operating modes of the compressed air recovery device are controlled by the control unit 122 (FIG. 10), which may be part of a compact assembly (control module 133). Corresponding algorithms for implementing the described method of operation of the compressed air recovery device are stored or programmed in the control unit 122.

All features described in the above description of the figures, in the claims, and in the introduction of the description can be applied both individually and in any combination. The invention is therefore not limited to the feature combinations described and claimed. Rather, any feature combinations are to be considered as disclosed.

1. A compressed air recovery device comprising
at least one compressed air inlet (1), to which a compressor (2) can be connected,
a pressure line (3) connected to the compressed air inlet (1),
a system pressure line (5), which is connected via a check valve (4) to the pressure line (3),
a drying device (11) arranged in the pressure line (3),
a bleed line (14), in which a pneumatically actuatable bleed valve (15) is arranged, branching off from the pressure line (3) between the compressed air inlet (1) and the drying device (11),
a regeneration path (22), which can be connected, according to the switch position of a bleed control valve (23), to the system pressure line (5) or to a line connected to the system pressure line (5), in particular a compressed air consumer circuit (7, 8, 9, 10), and discharges between the drying device (11) and the check valve (4) into the pressure line (3),
an electrically actuatable feed control valve (17) for controlling the feed of compressed air to the compressed air inlet (1),
characterized in that
an opening of the regeneration path (22) with full passage cross-section is linked to the position both of the feed control valve (17) and of the bleed control valve (23).

2. The compressed air recovery device as claimed in claim 1,
characterized in that
the regeneration path (22) comprises a regeneration pressure line (31) connected to the bleed control valve (23) and a parallel line (32) connected to the feed control valve (17).

3. The compressed air recovery device as claimed in claim 1,
characterized by
such an arrangement of the feed control valve (17) and of the bleed control valve (23) that the regeneration path (22) is only released with the simultaneous presence of the switch positions of the feed control valve (17) and of the bleed control valve (23) provided for the regeneration mode.

4. The compressed air recovery device as claimed in claim 3,
characterized in that
the regeneration path (22) has a regeneration valve arrangement (35), which can be switched cumulatively into the open position of the regeneration path (22) by actuation both of the feed control valve (17) and of the bleed control valve (23).

5. The compressed air recovery device as claimed in claim 3,
characterized in that,
the regeneration valve arrangement (35) and either the feed control valve (17) or the bleed control valve (23) are arranged in the regeneration path (22), wherein the regeneration valve arrangement (35) is connected controllably to the respective other valve (bleed control valve 17/feed control valve 23), which is not arranged in the regeneration path (22).

6. A compressed air recovery device, comprising
at least one compressed air inlet (1), to which a compressor (2) can be connected,
a pressure line (3) connected to the compressed air inlet (1),
a system pressure line (5), which is connected via a check valve (4) to the pressure line (3),
a drying device (11) arranged in the pressure line (3),
a bleed line (14), in which a pneumatically actuatable bleed valve (15) is arranged, branching off from the pressure line (3) between the compressed air inlet (1) and the drying device (11),
a regeneration path (22), which can be connected, according to the switch position of a bleed control valve (23), to the system pressure line (5) or to a line connected to the system pressure line (5), in particular a compressed air consumer circuit (7, 8, 9, 10), and discharges between the drying device (11) and the check valve (4) into the pressure line (3),
an electrically actuatable feed control valve (17) for controlling the feed of compressed air to the compressed air inlet (1),
characterized in that
a recovery module (126) comprising a drying device (126-11) is provided in a parallel pressure line (142) arranged parallel to the pressure line (3) and which, alternatively to the pressure line (3), can be released by a shuttle valve (145).

7. The compressed air recovery device as claimed in claim 6,
characterized in that
the shuttle valve (145) is pneumatically actuatable and is linked to the actuation of the bleed valve (15) of a primary module (141) of the compressed air recovery device (140).

8. A compressed air recovery device, comprising
at least one compressed air inlet (1), to which a compressor (2) can be connected,
a pressure line (3) connected to the compressed air inlet (1),
a system pressure line (5), which is connected via a check valve (4) to the pressure line (3),
a drying device (11) arranged in the pressure line (3),
a bleed line (14), in which a pneumatically actuatable bleed valve (15) is arranged, branching off from the pressure line (3) between the compressed air inlet (1) and the drying device (11),
a regeneration path (22), which can be connected, according to the switch position of a bleed control valve (23), to the system pressure line (5) or to a line connected to the system pressure line (5), in particular a compressed air consumer circuit (7, 8, 9, 10), and discharges between the drying device (11) and the check valve (4) into the pressure line (3),
an electrically actuatable feed control valve (17) for controlling the feed of compressed air to the compressed air inlet (1),
characterized in that
the bleed control valve (23) is formed as a pneumatically actuatable governor valve (103), which is arranged in the regeneration path (22) and can be controlled constantly by the system pressure (P SYS) in the system pressure line (5) or by a line connected to the system pressure line (5), in particular a compressed air consumer circuit (7, 8, 10) which is not pressure-limited.

9. The compressed air recovery device as claimed in one of the preceding claims,
characterized in that
the feed control valve (17) is connected via its service connector (20) to a compressor control line (21) of a compressor (2), wherein a supply connector (18) of the feed control valve (17) is connected to the system pressure line (5) or one of the compressed air consumer circuits (7, 8, 9, 10).

10. The compressed air recovery device as claimed in one of the preceding claims,
characterized in that
the bleed valve (15) is arranged so as to be pneumatically controllable by the bleed control valve (23).

11. The compressed air recovery device as claimed in one of the preceding claims,
characterized in that
a bleed connector (19) of the feed control valve (17) is connected to the regeneration path (22).

12. A compressed air supply system for a vehicle, comprising
a) a compressed air recovery device as claimed in one of claims 1 to 11,
b) a compressor (2),
c) a multi-circuit protection valve (6) connected to the system pressure line (5) and to which individual compressed air consumer circuits (7, 8, 9, 10) are connected,
d) an electronic control unit (122) for generating electric valve control signals,
characterized in that
the compressed air recovery device (121), the multi-circuit protection valve (6) and the control unit (122) form modular assemblies, wherein the compressed air recovery device (121) is arranged in a pneumatic recovery module (126, 126a), with the exception of the feed control valve (127).

13. The compressed air supply system as claimed in claim 12,
characterized in that
a control module (131), which contains the control unit (122), can be fitted on the assembly of the multi-circuit protection valve (6) and has line portions to at least one of the compressed air consumer circuits (7, 8, 9, 10), wherein a pressure sensor (132, 132a, 132b, 132c) is arranged in at least one of the line portions of the compressed air consumer circuits (7, 8, 9, 10) and is connected to the control unit (122).

14. The compressed air supply system as claimed in claim 12 or 13,
characterized in that
the control unit (122) is designed for the parallel control of a plurality of systems of a vehicle.

15. The compressed air supply system as claimed in one of claims 12 to 15,
characterized in that
the feed control valve (127) is assigned to the compressor (2).

16. The compressed air supply system as claimed in one of claims 12 to 16,
characterized in that
the compressed air recovery device (160) has two or more recovery modules (126, 126a) connected in parallel, which each have a pneumatically actuatable governor valve (126-103, 126-103a) as a bleed control valve (23) and can be activated alternatively by a shuttle valve (155).

17. A recovery module for a compressed air recovery device as claimed in one of claims 1 to 11 or a compressed air supply system as claimed in one of claims 12 to 16, said recovery module having exclusively pneumatic elements, namely
a compressed air inlet (126-1E), to which a compressor (2) can be connected,
a pressure line (126-3) connected to the compressed air inlet (126-1E),
a system pressure line (126-5), which is connected via a check valve (126-4) to the pressure line (126-3) and leads to a compressed air outlet (126-1A),
a drying device (126-11) arranged in the pressure line (126-3),
a bleed line (126-14), in which a pneumatically actuatable bleed valve (126-15) is arranged, branching off from the pressure line (126-3) between the compressed air inlet (126-1E) and the drying device (126-11),
a regeneration path (126-22), which branches off from the system pressure line (126-5) and discharges between the drying device (126-11) and the check valve (126-4) into the pressure line (126-3),
a bleed control valve, which is arranged in the regeneration path (126-22) and is formed as a pneumatically actuatable governor valve (126-103), which can be controlled constantly by the system pressure (P SYS) in the system pressure line (126-5).

18. The recovery module as claimed in claim 17,
characterized in that
a control inlet (126-25) of the bleed valve (126-15) is connected to a regeneration pressure line (126-101) between the governor valve (126-103) and the pressure line (126-3).

19. A method for operating a compressed air recovery device, wherein
in a conveying mode, compressed air is conveyed via a pressure line (3) and a drying device (11) arranged in the pressure line (3) via a check valve (4) into a system pressure line (5),
in a regeneration mode, a bleed control valve (23) releases a regeneration path (22) between the system pressure line (5) or a line connected to the system pressure line (5), in particular a compressed air consumer circuit (7, 8, 9, 10), and the pressure line (3), and allows compressed air to flow through the drying device (11) through the regeneration path (22), against a direction of flow in the conveying mode,
the compressed air feed to the compressed air recovery device (100; 110; 121) can be controlled by means of an electrically actuatable feed control valve (17),
characterized in that
the bleed control valve (23) is pneumatically actuatable by the system pressure (P SYS) in the system pressure line (5) or by a line connected to the system pressure line (5), in particular by a compressed air consumer circuit (7, 8, 10) which is not pressure-limited, and, if a switch pressure (PU) is present, releases the regeneration path (22) and, when the system pressure (P SYS) falls to a switch-back pressure (PR), blocks the regeneration path (22), wherein a desired operating mode of the compressed air recovery device (100, 110; 121) is controlled by means of the electrically actuatable feed control valve (17) with consideration of the system pressure (P SYS) by interrupting the compressed air feed in a conveying mode, as a desired operating mode, when a predetermined switch-off value (PA) of the system pressure (P SYS) is reached, this value being lower than the switch pressure (PU) of the bleed control valve (23), and by switching on and maintaining the compressed air feed when a regeneration mode is requested until the system pressure (P SYS) exceeds the switch pressure (PU) of the bleed control valve (23) and the bleed control valve (23) is switched.

20. The method as claimed in claim 19,
characterized in that
the switch state (176) of the bleed control valve (23) is monitored and the compressed air feed is interrupted when a change to the switch state (176) is identified due to the fact that the switch pressure (PU) has been exceeded.

21. The method as claimed in claim 19 or 20,
characterized in that
the volume of moisture (172) received by the drying device (11) is determined and is used as a basis for a request for regeneration of the drying device (11).

22. A control module comprising a control unit (122), to which a signal outlet (134) and/or an internal signal line is/are assigned for connection of an electrically actuatable feed control valve (127) of a compressed air recovery device (100, 110; 121) as claimed in one of claims 1 to 11 or of a compressed air supply system as claimed in one of claims 12 to 16, wherein a control signal of the control unit (122) for the feed control valve (127) can be emitted via the signal outlet (134) and/or the signal line, and a compressed air feed to the compressed air recovery device (100, 110; 121) can be controlled via the control signal, wherein the control unit (122) of the control module (131) is formed in such a way that, under consideration of a system pressure (P SYS) in a system pressure line (5) of the compressed air recovery device (100, 110; 121) or of a line connected to the system pressure line (5), a desired operating mode of the compressed air recovery device (100, 110; 121) can be controlled by interrupting the compressed air feed in a conveying mode, as a desired operating mode, and with consideration of the system pressure (P SYS), when a predetermined switch-off value (PA) of the system pressure (P SYS) is reached, said value being lower than a switch pressure (PU) of a pneumatically actuatable bleed control valve (23) of the compressed air recovery device, and by maintaining the compressed air feed, when there is a request for a regeneration mode, until the system pressure (P SYS) exceeds the switch pressure (PU) of the bleed control valve (23).

23. A vehicle comprising a compressed air recovery device as claimed in one of claims 1 to 11, a recovery module as claimed in claim 12 or 13, a compressed air supply system as claimed in one of claims 14 to 18, and/or a control module as claimed in claim 22.
